(19) United States
(12) Patent Application Publication
(10) Pub. No.: US 2009/0177500 A1
(43) Pub. Date: Jul. 9, 2009

(54) SYSTEM AND METHOD FOR NUMERICAL RISK OF LOSS ASSESSMENT OF AN INSURED PROPERTY

(76) Inventor: Michael Swahn, Atlanta, GA (US)

Correspondence Address: Balser & Grell IP Law LLC, 4307 Jones Bridge Circle, Norcross, GA, 30092, US

(21) Appl. No.: 12/348,824

(22) Filed: Jan. 5, 2009

Related U.S. Application Data
(60) Provisional application No. 61/010,081, filed on Jan. 4, 2008.

(51) Int. Cl. G06Q 40/00

(52) U.S. Cl. 705/4

(57) ABSTRACT

A system and method for numerical risk of loss assessment of an insured property, in general, comprising the steps of evaluating one or more risk criteria and category for each property area, subsystem or sub-area utilizing objective evaluation criteria and matrix to assess the risk of loss numerical rating for each criteria and category from 1-10 based on an objective analysis of the property's subsystems or sub-areas; averaging the risk criteria ratings across each property area, subsystem, or sub-area for each risk criteria to arrive at a category average); and averaging the category averages for each of the one or more category to arrive at an overall total risk of loss rating or score for the property.

### PRIORITY CLAIM TO RELATED US APPLICATIONS

To the full extent permitted by law, the present United States Non-Provisional patent application claims priority to and the full benefit of United States Provisional patent application entitled “System and Method for Numerical Risk of Loss Assessment of an Insured Property”, filed on Jan. 4, 2008 having assigned Ser. No. 61/010,081, incorporated entirely herein by reference.

### COPYRIGHT NOTICE

A portion of the disclosure of this patent document contains material which is subject to copyright protection. The copyright owner has no objection to the facsimile reproduction by anyone of the patent document or patent disclosure as it appears in the U.S. Patent and Trademark Office patent file or records, but otherwise reserves all copyright rights whatsoever.

### FIELD OF THE INVENTION

The present invention relates generally to operator interface processing and more specifically, to a system and method for numerical property risk of loss assessment and to an analysis tool and matrix for determining an overall numerical property loss rating for a plant or other physical property.

### BACKGROUND OF THE INVENTION

Insurance is a form of risk management primarily used to hedge against the risk of a contingent loss and to spread the loss across multiple insured parties. Businesses often acquire multiple forms of insurance to insure against various known and unknown perils, whether general liability, property, business interruption, workers compensation, inland marine, ocean cargo, umbrella and/or excess liability. For example, property loss insurance provides protection against most risks to property, such as fire, theft, and weather damage. Specialized forms of property insurance cover specific types of loss, such as fire, explosion, lightning, flood, earthquake, wind and the like. In addition, property loss is insured in two main ways, either as open perils covering all causes of loss not specifically excluded in the policy, or as named perils covering specified losses named in the policy.

Typically, when a medium to large size business seeks to insure its factories, warehouse, plant, equipment, buildings and other property from risk of loss, several insurers or insurance brokers bid on and participate in writing the property loss policy, offering shared or layered exposure for such insurance providers. More specifically, often a prime insurer or broker is selected from a group of insurers, wherein the prime typically underwrites the largest portion of the policy while participating insurers underwrite the remainder in an effort to spread catastrophic loss across multiple insurers.

Each insurer who is bidding on the property loss coverage, whether for some or all of the required value sought to be insured, sends an evaluator with property loss engineering experience on site to analyze the property. The property loss engineer conducts an extensive walk-through, performs a review of the property identifying potential risks, and code violations, and suggests and recommends safety procedures and systems to reduce such risks in a written report detailing the evaluation. Ultimately, such text information is used to determine an insurance rate, called a premium, to be charged for a specified amount of property loss insurance coverage. Typically, each insurer has developed methods for identifying potential risks and quantifying costs of property loss insurance coverage for specific industry segments, such as automotive, manufacturing, power generation, transportation and the like. Some insurers maintain their methods and analysis techniques as proprietary information. When varying methods and analysis techniques are utilized by the different insurers participating in a multi-insurer property loss insurance policy, the resulting policy is based on varying identified potential risks, code violations, suggested safety procedures and systems, upgrades and quantified costs, variably forming the basis of each insurer's property loss analysis and ultimately the premium requested for a specified amount of property loss insurance to provide risk of loss coverage for the identified property.

In addition, some insurers may utilize a market or sales comparison approach, wherein the insurer arrives at a premium requested for a specified amount of property loss insurance by comparing the subject property directly with comparable properties recently insured or based on the estimated value to rebuild the physical or structured property. Under this approach, the property loss engineer compares each of the comparable property's important attributes with the corresponding attributes of the property being evaluated, under the general distinctions of time, location, risk factors, physical characteristics and the like, and considers all dissimilarities in terms of their probable effect upon the premium requested for a specified amount of property loss insurance. If a significant item in the comparable property has less of a risk factor than the subject property, a minus (−) dollar adjustment is made to the premium, thus reducing the indicated value of the subject. However, if a significant item in the comparable property is of higher risk than the subject property, a plus (+) dollar adjustment is made to the requested premium for a specified amount of property loss insurance for the identified property.

In view of the present invention, the prior art is deficient in many ways. More specifically, the insured party requesting insurance coverage is unable to directly compare methods and analysis techniques utilized in preparation of each quote for coverage submitted by each insurer of the multi-insurer policy. For example, if insurer A and insurer B submit quotes for the same property and for the same segment of the property loss insurance coverage, the insured party is unable to determine or evaluate the assumptions and underlying premises that went into the analysis, which likely resulted in two different quotes for the same insurance.

Nonetheless, it is readily apparent that there is a recognizable need for a system and method for numerical risk loss assessment, wherein such a system and method provides the insured party with the ability to evaluate the assumptions and underlying premises that went into the risk of loss analysis which resulted in the premium requested for a specified amount of property loss insurance in order to provide coverage for the identified property, thus enabling the party seeking insurance to make a direct comparison between sets of assumptions and underlying premises utilized by each insurer to form a quote, and thereby, enabling the insured party to challenge such assumptions and underlying premises and ultimately make a direct comparison between insurance coverage providers.

### BRIEF SUMMARY OF THE INVENTION

Briefly described, in a preferred embodiment, the system and process overcomes the above-mentioned disadvantages, and meets the recognized need for such a system and process by providing a system and method for numerical risk of loss assessment of an insured property, wherein an overall risk of loss rating for a plant or other physical property is derived from the average risk of loss rating of one or more criteria and category for a given property such as construction, occupancy, protection, exposure, management programs, business continuity and the like, and wherein a property loss engineer conducts an extensive walk-through, performs a review of the property identifying potential risks, code violations, suggested safety procedures and systems based on objective criteria and assigns a numerical score for each criteria and category. Such system and method functions to enable the party seeking insurance to make a direct comparison between two insurance quotes and to evaluate the criteria forming the basis of each quote resulting in the premium requested for the property loss insurance coverage on a particular property.

According to its major aspects and broadly stated, the system and process in its preferred form is a system and method for numerical risk of loss assessment of an insured property, in general, comprising the steps of evaluating one or more risk criteria and category for each property area, subsystem or sub-area, utilizing objective evaluation criteria and matrix to assess the risk of loss and assign a numerical rating for each criteria and category from 1-10 based on an objective analysis of the property's subsystems or sub-areas; averaging the risk criteria ratings across each property area, subsystem, or sub-area for each risk criteria to arrive at a category average; and averaging the category averages for each of the one or more category to arrive at an overall total risk of loss rating or score for the property.

More specifically, the preferred embodiment of the present system and process utilizes an objective analysis to determine the risk of loss rating for each area, subsystem, or sub-area within a property by comparing the actual conditions of the area, subsystem, or sub-area to a risk summary description, matrix, table or the like categorizing conditions as numerical risk of loss ratings of poor (1-3), fair (4-6), good (7-9), or excellent (10). The numerical risk of loss assessment is based on an objective analysis of the property's subsystem or sub-area, wherein a property loss engineer conducts an extensive walk-through and analyzes each area, subsystem, or sub-area based on one or more risk criteria and selects a numerical risk of loss rating from 1-10 for each criteria based on objective factors set forth in the risk summary matrix, wherein the risk summary matrix includes descriptions, matrix, tables, and audio/visual reference criteria to differentiate each of the ratings from 1-10 for each subsystem or sub-area of the property.

In a further preferred embodiment of the invention, a computer-based method of assessing numerical risk of loss of a property, includes the following steps: selecting a sub-area within the property to perform the numerical risk of loss assessment, identifying one or more categories to evaluate risk of loss for said selected sub-area, identifying one or more criteria within each category of said one or more categories to evaluate risk of loss for said selected sub-area, identifying one or more matrix for objectively evaluating risk of loss for each of said one or more criteria, obtaining an interactive computer software program capable of presenting each of said one or more criteria for each of said category to an evaluator, and determining a numerical score for each of said one or more criteria for each of said category based on objective evaluation of said sub-area to said matrix.

Accordingly, a feature of the system and method for numerical risk of loss assessment is its ability to provide an overall plant rating based on the average of category averages (or area averages of criteria) criteria ratings of a property's subsystem or sub-area to arrive at an overall numerical property loss rating for the property.

Another feature of the system and method for numerical risk of loss assessment is its ability to provide an alternative to the current arbitrary and/or proprietary systems and methods for identifying risk of loss for a property and to quantify the costs of property loss insurance coverage utilizing an industry standard objective system and method to standardize property risk of loss insurance evaluations, insurance quotes, insurance premiums and insurance coverage.

Still another feature of the system and method for numerical risk of loss assessment is its ability to determine a plurality of property loss criteria grouped within subsets, and to average each subset and then calculate an overall property risk of loss as a numerical average of the subset averages.

Yet another feature of the system and method for numerical risk of loss assessment is its ability to trend and perform statistical analysis and error calculations on property loss criteria and averages of property loss criteria.

Yet another feature of the system and method for numerical risk of loss assessment is its ability to perform an objective analysis of each subsystem or sub-area within a property by comparing the actual conditions of the subsystem or sub-area to a risk summary matrix and to numerically categorize the risk based on one or more risk criteria.

Yet another feature of the system and method for numerical risk of loss assessment is its ability to provide a system and apparatus for reproducibly evaluating each subsystem or sub-area within a property by recording the actual conditions of the subsystem or sub-area via text, audio, video, still pictures and the like.

Yet another feature of the system and method for numerical risk of loss assessment is its ability to provide a system and apparatus for automated evaluation and assignment of numerical property loss ratings for each subsystem or sub-area within a property.

Yet another feature of the system and method for numerical risk of loss assessment is its ability to provide a system and apparatus for performing averaging, calculations, trending and statistical analysis on numerical property loss ratings for each subsystem or sub-area within a property.

Yet another feature of the system and method for numerical risk of loss assessment is its ability to enable a property loss engineer to input numerical property loss ratings for each subsystem or sub-area and have such information stored and available to other users on a remotely accessible server or system or via the Internet.

In accordance with still further aspects of the system and method for numerical risk of loss assessment, computer-based instruction windows may automatically appear to guide the property loss engineer with the determination of the property risk of loss rating or score for each criteria, subsystem or sub-area within a property by providing comparables via text, audio, video, still pictures and the like.

These and other features of the system and method for numerical risk of loss assessment will become more apparent to those ordinarily skilled in the art from the following description and claims when read in light of the accompanying drawings.

### BRIEF DESCRIPTION OF THE DRAWINGS

The present invention will be better understood by reading the Detailed Description of the Preferred and Selected Alternative Embodiments with reference to the accompanying drawing figures, in which like reference numerals denote similar structure and refer to like elements throughout, and in which:

FIG. 1 is a block diagram of a computer system of the system and method for numerical risk of loss assessment according to a preferred embodiment;

FIG. 2 is a decision diagram of a method for defining the total insured value, according to a preferred embodiment;

FIG. 3 is a process diagram of a method for numerical risk of loss assessment, according to the preferred embodiment;

FIG. 4 is a template exemplar of a user interface of the communication method of FIG. 3, according to the preferred embodiment;

FIG. 5 depicts an illustrative embodiment of a screen showing an exemplary risk of loss assessment summary, according to the preferred embodiment;

FIG. 6 depicts an illustrative embodiment of a risk of loss matrix for management recommendations according to a preferred embodiment;

FIG. 7 depicts an illustrative embodiment of a risk of loss matrix for physical recommendations according to a preferred embodiment;

FIG. 8 depicts an illustrative embodiment of a risk of loss matrix for construction types as defined in the 18^{th} edition of the NFPA Fire Protection Handbook Section 7, Chapter 2 according to a preferred embodiment;

FIG. 9 depicts an illustrative embodiment of a risk of loss matrix for new construction according to a preferred embodiment;

FIG. 10A depicts risk of loss definitions for process hazards according to a preferred embodiment of the present invention;

FIG. 10B depicts an illustrative embodiment of a risk of loss matrix for process hazards according to a preferred embodiment;

FIGS. 11A and 11B depicts risk of loss definitions matrix and matrix for storage hazards according to a preferred embodiment;

FIG. 12A depicts a summary table for calculating a risk of loss for fire protection according to the preferred embodiment;

FIG. 12B depicts an illustrative embodiment of a risk of loss matrix for sprinklers and fixed fire protection according to a preferred embodiment;

FIG. 12C depicts an illustrative embodiment of a risk of loss matrix for local fire department and adjustments for internal fire brigade according to a preferred embodiment;

FIG. 12D depicts an illustrative embodiment of a risk of loss matrix for internal water supply and adjustments for proximity to public fire hydrants according to a preferred embodiment;

FIG. 13 depicts an illustrative embodiment of a risk of loss matrix for fire equipment inspection according to a preferred embodiment;

FIG. 14A depicts an illustrative embodiment of a risk of loss matrix for surveillance equipment and adjustments for goods according to a preferred embodiment;

FIG. 14B depicts an illustrative embodiment of a risk of loss matrix for surveillance equipment and adjustments for crimes and areas according to a preferred embodiment;

FIG. 14C depicts an illustrative embodiment of a risk of loss matrix for surveillance equipment and adjustments for automatic alarms and sprinklers according to a preferred embodiment;

FIG. 15A-C depict illustrative embodiments of a risk of loss matrix and tables for exposure according to a preferred embodiment;

FIG. 16 depicts an illustrative embodiment of a risk of loss matrix for perils other than fire according to a preferred embodiment;

FIG. 17A-O depicts an illustrative embodiment of a risk of loss matrix for Housekeeping, Impairment, Smoking, Maintenance, Maintenance Score, Employee Training, Emergency Plan, Pre-Emergency Plan, Hot Work, Management of Contractors, Contractor Score, Management of Change, Management of Change Score, Self Inspection, and Self Inspection Score according to a preferred embodiment of the present invention;

FIG. 18 depicts an illustrative embodiment of a risk of loss process, matrix, and table for critical utilities according to a preferred embodiment of the present invention; and

FIG. 19 depicts an illustrative embodiment of a risk of loss process and matrix for business continuity plan according to a preferred embodiment of the present invention.

### DETAILED DESCRIPTION OF THE INVENTION

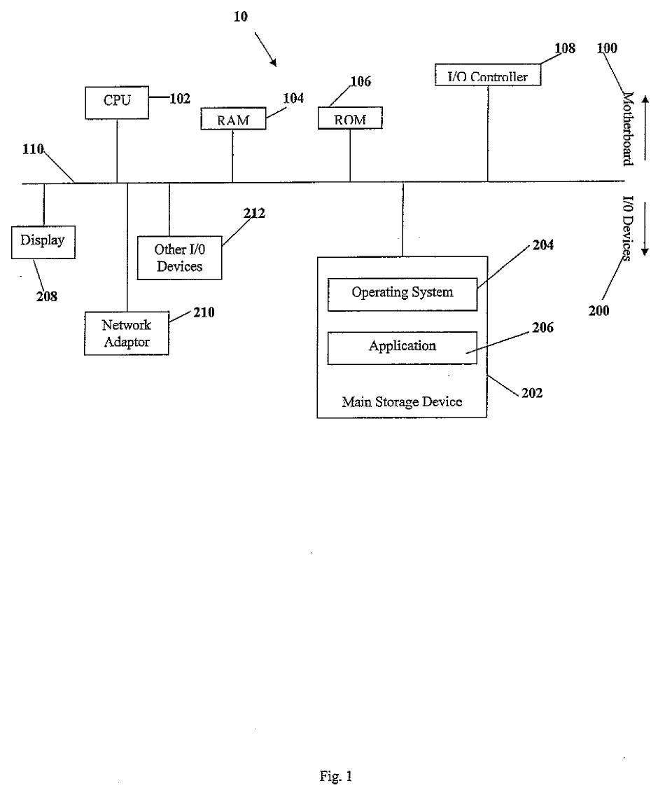

In describing the preferred and alternative embodiments of the present invention, as illustrated in FIGS. 1-19, specific terminology is employed for the sake of clarity. The invention is not, however, intended to be limited to the specific terminology so selected, and it is to be understood that each specific element includes all technical equivalents that operate in a similar manner to accomplish a similar function.

As will be appreciated by one of skill in the art, the present invention may be embodied as a method, data processing system, or computer program product. Accordingly, the present invention may take the form of an entirely hardware embodiment, entirely software embodiment or an embodiment combining software and hardware aspects. Furthermore, the present invention may take the form of a computer program product on a computer-readable storage medium having computer-readable program code means embodied in the medium. Any suitable computer readable medium may be utilized including hard disks, ROM, RAM, CD-ROMs, electrical, optical or magnetic storage devices.

The present invention is described below with reference to flowchart illustrations of methods, apparatus (systems) and computer program products according to embodiments of the present invention. It will be understood that each block or step of the flowchart illustrations, and combinations of blocks or steps in the flowchart illustrations, can be implemented by computer program instructions. These computer program instructions may be loaded onto a general purpose computer, special purpose computer, or other programmable data processing apparatus to produce a machine, such that the instructions, which execute on the computer or other programmable data processing apparatus create means for implementing the functions specified in the flowchart block or blocks/step or steps.

These computer program instructions may also be stored in a computer-usable memory that can direct a computer or other programmable data processing apparatus to function in a particular manner, such that the instructions stored in the computer-usable memory produce an article of manufacture including instruction means which implement the function specified in the flowchart block or blocks/step or steps. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks/step or steps.

Accordingly, blocks or steps of the flowchart illustrations support combinations of means for performing the specified functions, combinations of steps for performing the specified functions and program instruction means for performing the specified functions. It should also be understood that each block or step of the flowchart illustrations, and combinations of blocks or steps in the flowchart illustrations, can be implemented by special purpose hardware-based computer systems, which perform the specified functions or steps, or combinations of special purpose hardware and computer instructions.

Computer programming for implementing the present invention may be written in various programming languages, such as conventional C calling, database languages such as Oracle or .NET. However, it is understood that other source or object oriented programming languages, and other conventional programming language may be utilized without departing from the spirit and intent of the present invention.

Referring now to FIG. 1, there is illustrated a block diagram of a computer system 10 that provides a suitable environment for implementing embodiments of the present invention. The computer architecture shown in FIG. 1 is divided into two parts—motherboard 100 and the input/output (I/O) devices 200. Motherboard 100 preferably includes subsystems such as central processing unit (CPU) 102, random access memory (RAM) 104, input/output (I/O) controller 108, and read-only memory (ROM) 106, also known as firmware, which are interconnected by bus 110. A basic input output system (BIOS) containing the basic routines that help to transfer information between elements within the subsystems of the computer is preferably stored in ROM 106, or operably disposed in RAM 104. Computer system 10 further preferably includes I/O devices 200, such as main storage device 202 for storing an operating system 204 and application program(s) 206 and display 208 for visual output, respectively. Main storage device 202 preferably is connected to CPU 102 through a main storage controller (represented as 108) connected to bus 110. Network adapter 210 allows the computer system to send and receive data through communication devices. One example of a communications device is a modem including both cable and digital subscriber line (DSL). Other examples include a transceiver, a set-top box, a communication card, a satellite dish, an antenna, or any other network adapter capable of transmitting and receiving data over a communications link that is either a wired, optical, or wireless data pathway.

Many other devices or subsystems 212 may be connected in a similar manner, including but not limited to, devices such as microphone, speakers, sound card, keyboard, pointing device (e.g., a mouse), floppy disk, CD-ROM player, digital camera and/or video recorder, DVD player, printer and/or modem each connected via an I/O adapter. Also, although preferred, it is not necessary for all of the devices shown in FIG. 1 to be present to practice the present invention, as discussed below. Furthermore, the devices and subsystems may be interconnected in different configurations from that shown in FIG. 1, or may be based on optical or biological processors or gate arrays, or some combination of these elements that is capable of responding to and executing instructions. The operation of a computer system such as that shown in FIG. 1 is readily known in the art and is not discussed in further detail in this application, so as not to overcomplicate the present discussion.

Moreover, computer system 10 is capable of delivering and exchanging data with other computer systems 10 through communication links such as the Internet, the World Wide Web, WANs, LANs, analog or digital wired and wireless telephone networks (e.g. PSTN, ISDN, or XDSL), radio, wireless, television, cable, satellite, and/or any other delivery mechanism for carrying and/or transmitting data or other information.

Moreover, computer system 10 may be implemented as a hand held and/or portable system for assisting a property loss engineer in collecting information, analyzing risk of loss, and objectively assigning a numerical ratings or scores while conducting an extensive walk through of a property.

Before proceeding with further substantive explanations of the present invention, it is important to clarify certain terminologies used herein for the purpose of better understanding of the present invention. First, the term “Normal Loss Expectancy (NLE)” should be interpreted broadly to mean the projected maximum combined property and business dollar loss from a single fire occurrence for which all active and passive protection systems and features are operating without impairment. Further, the term “Probable Maximum Loss (PML)” should be interpreted broadly to mean the maximum projected combined property and business interruption dollar loss from a single fire occurrence for which the most critical active protection system is impaired but all other active and passive protection systems and features are operating without impairment. Still further, the term “Maximum Foreseeable Loss (MFL)” should be interpreted broadly to mean the maximum projected combined property and business interruption dollar loss expected from a single fire occurrence for which all active systems are impaired and no effort is made to actively fight the fire. The fire under this loss scenario is only limited by a properly designed and maintained fire wall, physical separation, or lack of combustibles.

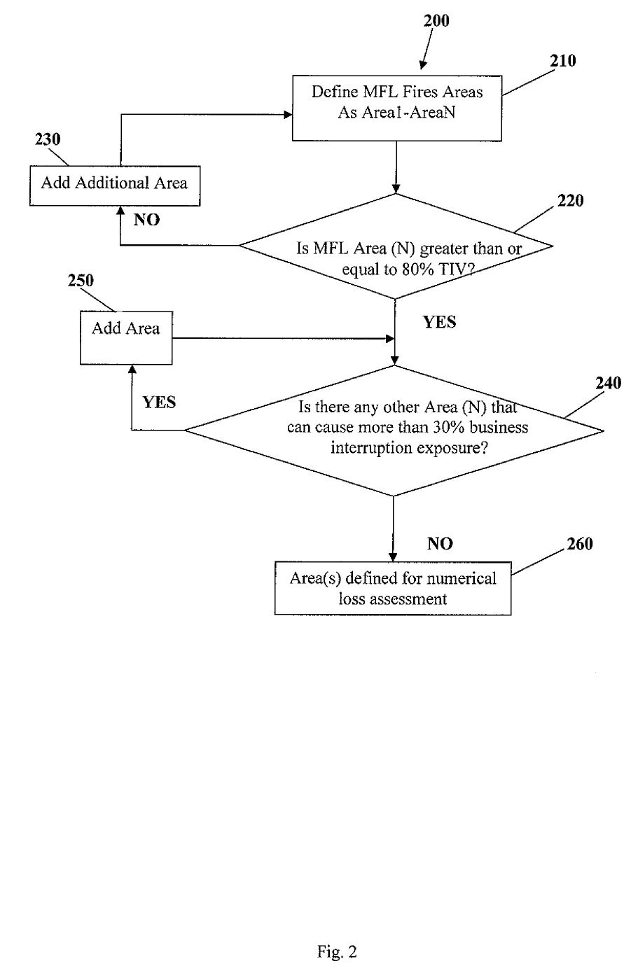

Referring now to FIG. 2, there is illustrated a preferred process 200 for determining the MFL areas which make up 80% or more of the total insured value. First, a property loss engineer or other evaluator identifies a property selected for a risk of loss assessment analysis, which may be a power plant, steel mill, manufacturing facility, or other commercial or residential property (Property). In step 210 of process 200, the Property under analysis for risk of loss assessment is divided into areas(1-N) (Area(N)) based on physical separations or MEL fire walls that divide the property between the structures or areas, which comprise the Property. For example, a typical manufacturing facility has a manufacturing area (Area1) and a storage area (Area2); however, additional areas may be identified depending on the structural set up of the Property selected for a risk loss assessment.

Next, in step 220 of process 200, Area1 is evaluated to determine whether or not Area1 comprises 80% or more of the total insured value (TIV) of the Property. If the area(s) of Area(N) do not comprise at least 80% of the TIV, process 200 proceeds to step 230, wherein an additional area (Area2), defined in step 210, is added to Area1. Next, process 200, returns to step 220, wherein Area1 and Area2 are evaluated to determine whether or not their combined areas comprise 80% or more of the total insured value (TIV) of the Property. Steps 210-230 continue to add area(s) to the previously identified area(s) until the combination of area(s) comprises 80% or more of the TIV for the Property. Upon determining that the selected area(s) comprises 80% or more of the TIV for the Property in step 220, process 200 proceeds to step 240.

In step 240 of process 200, each remaining Area(N) not identified in steps 210-230 is evaluated to determine whether or not the Area(N) could comprise 30% or more business interruption exposure for the entire Property. If an Area(N) qualifies as having 30% or more business interruption exposure potential, then process 200 proceeds to step 250 wherein such area is added to the areas previously identified in step 210-230. Steps 240 and 250 continue to add area(s) to the previously identified area(s) until the remaining Areas(N) are determined to have less than 30% business interruption exposure potential. Next, process 200 proceeds to step 260, wherein process 200 concludes having identified Areas(N) of Property as having 80% or more of the TIV for the Property and Areas(N) having 30% or more business interruption exposure. For example, if the Property under analysis for risk of loss assessment is divided into areas such as Area1 manufacturing, having 80% TIV, and Area2 storage, having 30% business interruption exposure, upon a property loss engineer utilizing process 200 to evaluate such Property, Area1 is selected in step 220 as an area having 80% or more TIV and Area2 is selected in step 240 as an area having 30% or more business interruption exposure.

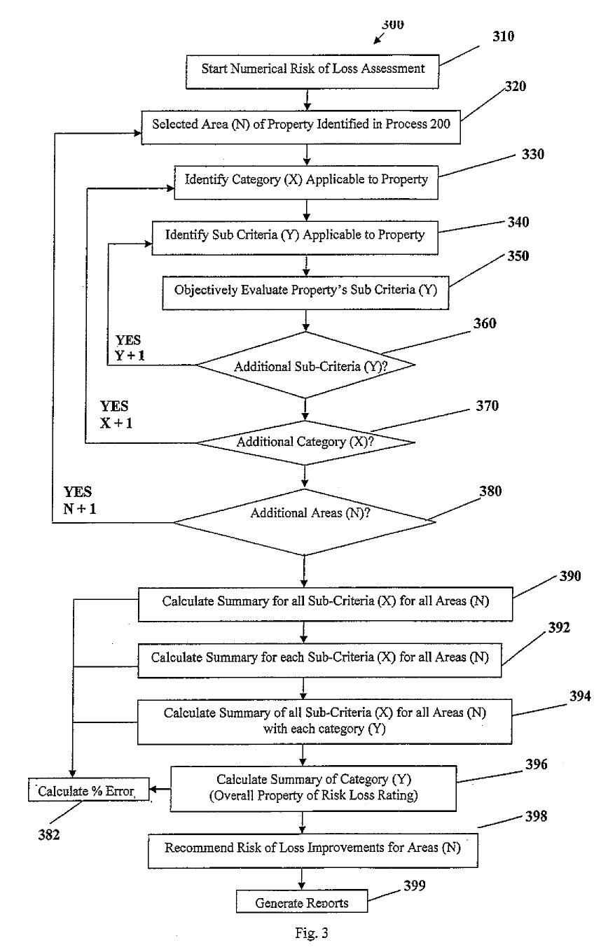

Referring now to FIG. 3, there is illustrated a preferred process 300 for identifying, evaluating and calculating the overall risk of loss rating for a Property. Process 300 may be implemented by computer system 10 or other similar hardware, software, device, computer, computer system, equipment, component, application, code, storage medium or propagated signal. Preferred process 300 starts with step 310, wherein process 300 preferably queries a property loss engineer or other evaluator (Evaluator) to start a risk of loss assessment of an identified Property. Such risk of loss assessment is preferably performed when an Evaluator conducts an extensive walk-through and performs a review of the property identifying potential risks, code violations, suggested safety procedures and systems and the like. However, it is contemplated herein that an assessment of an identified Property may alternatively be performed remotely by analyzing a multi-media presentation of such identified Property, such as a pre-recorded audio/video walk-through of the Property, or while viewing a real-time recording of a walk-through of such Property. Next, in step 320, process 300 preferably queries for the selection of an Area, such as Area1 of one or more Areas(N) identified in process 200. Next, in step 330, process 300 preferably queries for the identification of one or more categories, which are applicable to a risk of loss assessment of Area1 (Categories(X)). Next, in step 340, process 300 preferably queries for the identification of criteria under each identified Category(X) in step 330, which are further applicable to a risk of loss assessment of Area1 (Criteria (Y)). It is contemplated herein that some Categories may not require further division into criteria. Next, in step 350, process 300 preferably queries for an objective evaluation of Area1 based on Category(X), Criteria(Y) utilizing objective factors and matrix and the assignment of a numeric risk of loss rating to Criteria(Y) of Category(X) for Area1.

Preferably, objective factors for evaluating the actual conditions of Criteria(Y) of Category(X) for Area(N) include, but are not limited to, examples of written descriptions, matrix, tables, images, and/or audio/video of areas with standardized numeric risk of loss ratings, standardized industry classifications, laws and regulations, rules, regulations and code, guidelines, zoning, which are applicable to specific industries, types of property, equipment, and systems and the like (Objective Factors).

Next, in step 360, process 300 preferably queries whether additional Criteria(Y) under Category (1) require evaluation and assignment of a numerical rating or score. If yes, process 300 recursively returns to steps 340 and 350 until all Criteria(Y) under Categoryl have been evaluated for Area1 of Property. Otherwise, upon all Criteria(Y) being evaluated under Categoryl and no further Criteria(Y) requiring evaluation, under step 360 for Area1, process 300 preferably proceeds to step 370.

In step 370, process 300 preferably queries whether any additional Category(X) require an evaluation for Area1. If yes, process 300 recursively returns to steps 330, 340 and 350 until all Categories(X) and their Criteria(Y) have been evaluated for Area1 of Property. Otherwise, upon all Categories(X) being evaluated and no further Categories(X) requiring evaluation, under step 370 for Area1, process 300 preferably proceeds on to step 380.

In step 380, process 300 preferably queries whether any additional Area(N) of Property require an evaluation. If yes, process 300 recursively returns to steps 320, 330, 340 and 350 until all Areas(N) have been evaluated for Property. Otherwise, upon all Areas(N) being evaluated and no further Areas(N) requiring evaluation, under step 380 for Property, process 300 preferably moves to step 390.

Next, in step 390, process 300 calculates a summary of all Criteria(Y) for each Area(N) of Property based on the numerical risk of loss rating queried in steps 320 through 380 and assigned in step 350.

Next, in step 392, process 300 calculates a summary of each Criteria(Y) for all Areas(N) of Property based on the numerical risk of loss rating queried in steps 320 through 380 and assigned in step 350.

Next, in step 394, process 300 calculates a summary of all Criteria(Y) for all Areas(N) within each Category(X) based on the numerical risk of loss rating queried in steps 320 through 380 and assigned in step 350.

Next, in step 396, process 300 calculates a summary of all Category(X) summaries calculated in step 394 for Property. Moreover, process 300 calculates a summary of all Area(N) summaries calculated in step 390. Either summary calculated in this step 396 represents the overall numerical risk of loss rating for the Property.

It is contemplated herein that the summary calculated in steps 390 through 396 preferably is an average of such numerical risk of loss ratings, however, other mathematical and statistical analysis and statistical trending may be performed on such numerical risk of loss ratings, including but not limited to mean, median, weighted averages and the like.

Next, in step 382, process 300 preferably calculates a probable error percentage for each calculation step 390 through 394 and calculates an overall error percentage for step 396 due to the subjective analysis of comparing actual conditions to Objective Factors for each Criteria(Y), Category(X) and Area(N) of Property. Moreover, process 300 may calculate a probable error percentage for each calculation step 390 through 396 as between different Evaluators performing risk of loss assessment of the same or similar Properties. Mathematical and statistical analysis and statistical trending are readily known in the art and are not discussed in further detail in this application so as not to overcomplicate the present discussion.

Next, in step 398, process 300 preferably prompts and prioritizes recommended improvements in Areas(N) identified as high risk of loss by querying an Evaluator to select improvements for select Areas(N) of Property by recommending or prompting a selection of tasks, operations, system updates or upgrades to Areas(N) which have been identified as high risk of loss.

Next, in step 399, process 300 preferably prompts the generation of reports and upon a selection to generate reports, a summary of the evaluation and assessment of Property and its Criteria(Y), Category(X), Areas(N), calculations, probable errors and overall Property numerical risk of loss rating are generated.

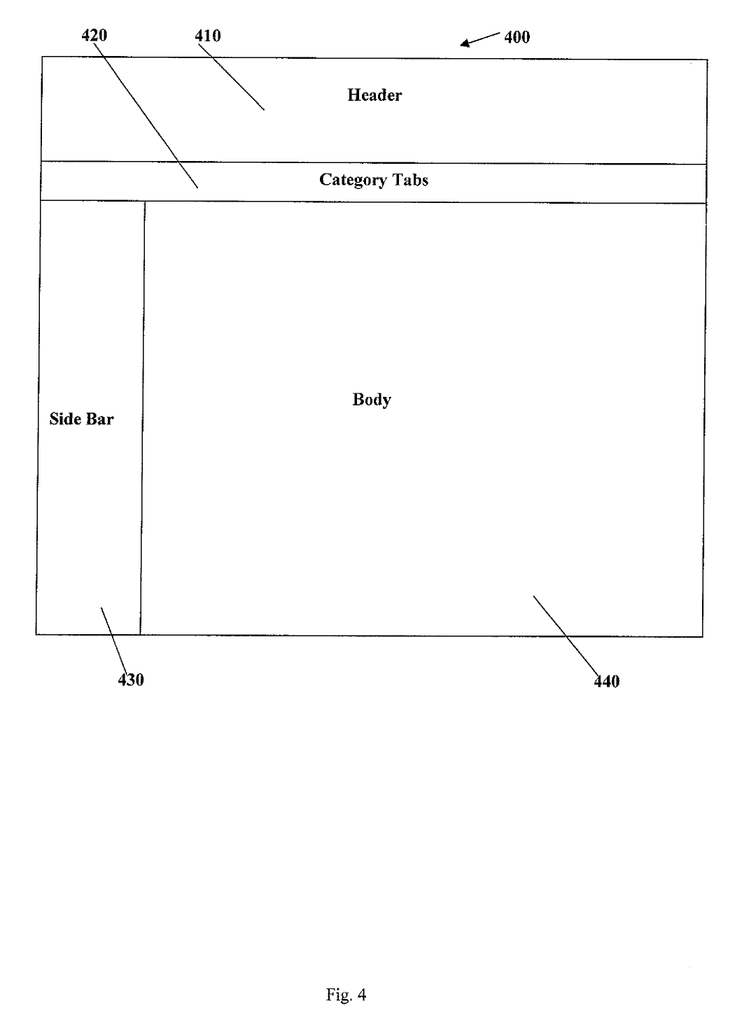

Referring to FIG. 4, template 400 preferably is a general user interface (GUI) computer screen such as a computer screen or website page(s) and the like having text, graphics, text entry windows, drop down selection windows, radial selection buttons, clickable buttons and the like. The Evaluator utilizing process 300 on computer system 10 preferably can personalize or customize template 400 with text, graphics, pictures, audio files, video files and the like. GUIs, computer screens and website pages are readily known in the art and are not discussed in further detail in this application, so as not to overcomplicate the present discussion. Moreover, website and GUT pages are stored in main storage device 202 or accessible via the Internet thru network adapter 210. Template 400 preferably includes but is not limited to header 410, category tabs 420, side bar 430, and body 440 which organize the page into regions having text, graphics, text entry windows, tabs, hyper links, drop-down selection windows, radial buttons, clickable buttons and the like. Any suitable format may be utilized for expression of the information.

In use, process 300 preferably summarizes an Evaluator selection of a numerical risk of loss ratings of 1-10, whether such selection is poor (1-3), fair (4-6), good (7-9), or excellent (10), for an Area(N) of Property for each Criteria (Y), of Category (X), in Area(N) in steps 320-380 in an assessment summary 500.

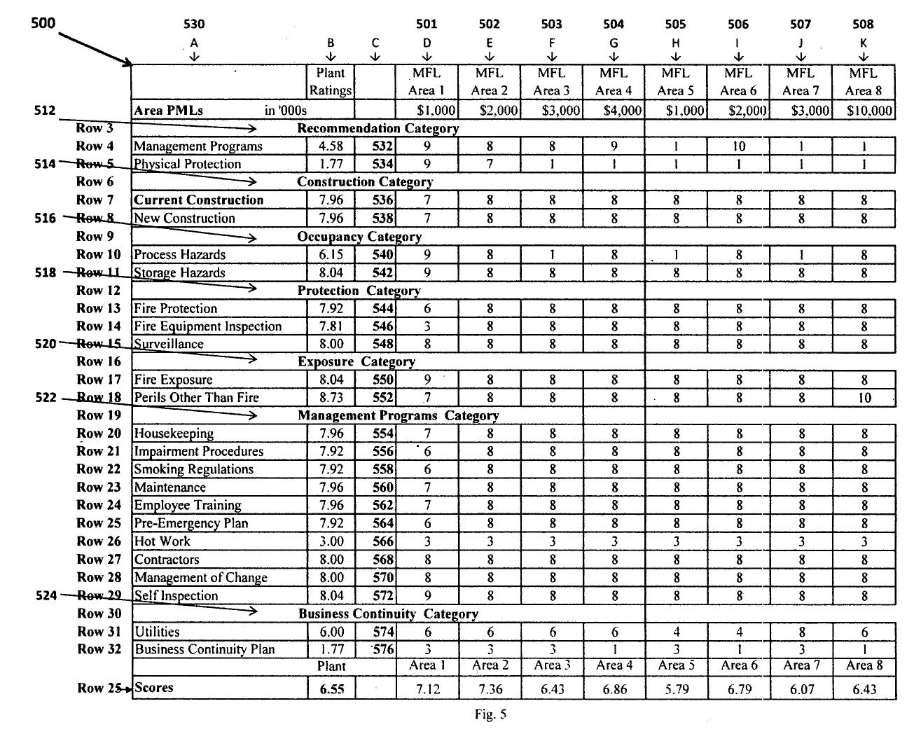

Referring now to FIG. 5, there is illustrated a computer screen showing an exemplary risk of loss assessment summary 500, wherein Areas(N) of process 300 of Property are set forth as Area 501, 502, 503, 504, 505, 506, 507, and 508, shown as headers for columns D-K in FIG. 5. Category (X) of process 300 is set forth as categories in column A in FIG. 5, and has categories of recommendations 512 in row 3, construction 514 in row 6, occupancy 516 in row 9, protection 518 in row 12, exposure 520 in row 16, management program 522 in row 19, and business continuity 524 in row 30 in FIG. 5. It is contemplated herein that different Categories(X) may be utilized in process 300, wherein such categories would be applicable to a risk of loss evaluation of a different Property and/or different industry segments.

Criteria (Y) of process 300 preferably are set forth as Criteria 530 in column A in FIG. 5. In this example, recommendations 512 preferably have two criteria 530 illustrated as management programs 532 and physical protection 534 in column C in FIG. 5. It is contemplated herein that different Criteria(Y) may be utilized in process 300, wherein such categories would be applicable to a risk of loss evaluation of a different Property and/or different industry segments.

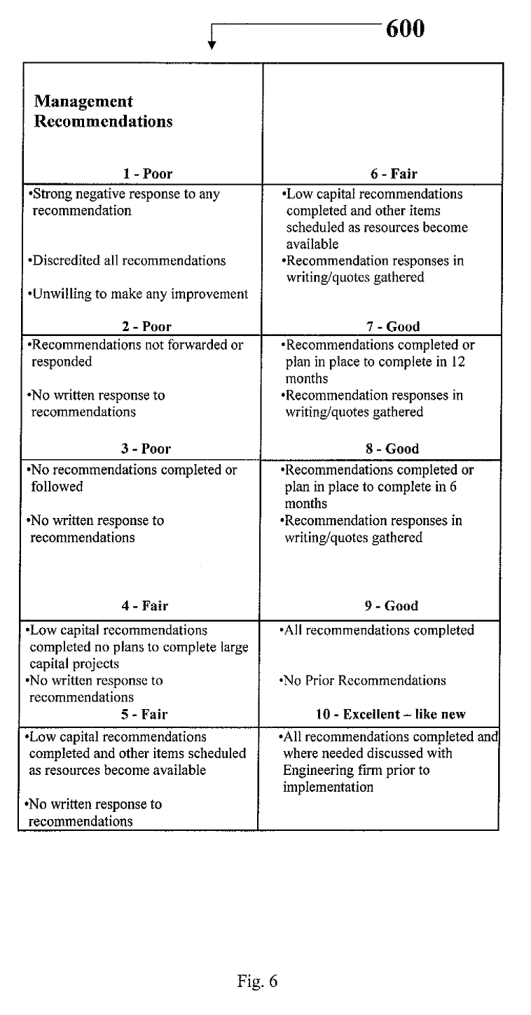

In use, process 300 preferably prompts an Evaluator assessing each Criteria (Y) of Category (X), in Area(N), in steps 320-380 to utilize Objective Factors set forth in FIGS. 6-19 to guide the selection of a numerical risk of loss rating of 1-10, whether such selection is poor (1-3), fair (4-6), good (7-9), or excellent (10) for an Area(N) of Property.

FIGS. 6-19 represent an exemplary embodiment of the matrices for Criteria(Y), setting forth the Objective Factors required to objectively assess the risk of loss of a steel plant. It is contemplated herein that other representative matrices may be developed setting forth the Objective Factors for assessing applicable Criteria(Y) and Category(X) for other properties and/or industry segments.

Referring now to FIG. 6, there is illustrated exemplary management programs 532 risk of loss assessment matrix 600, utilized to assess the management team overseeing Area(N) of Property. More specifically, matrix 600 preferably is utilized to assess management's willingness and/or diligence in implementing recommended risk of loss management recommendations in Areas 501-508, (Areas(N)) under evaluation in step 350 of process 300. Upon completing the assessment utilizing the Objective Factors in matrix 600, the next step is to insert the objectively determined numerical value of Area(N), based on matrix 600, into row 4 of FIG. 5. Preferably, matrix 600 is an objective management program risk of loss rating system, with descriptions for poor (1-3), fair (4-6), good (7-9), or excellent (10).

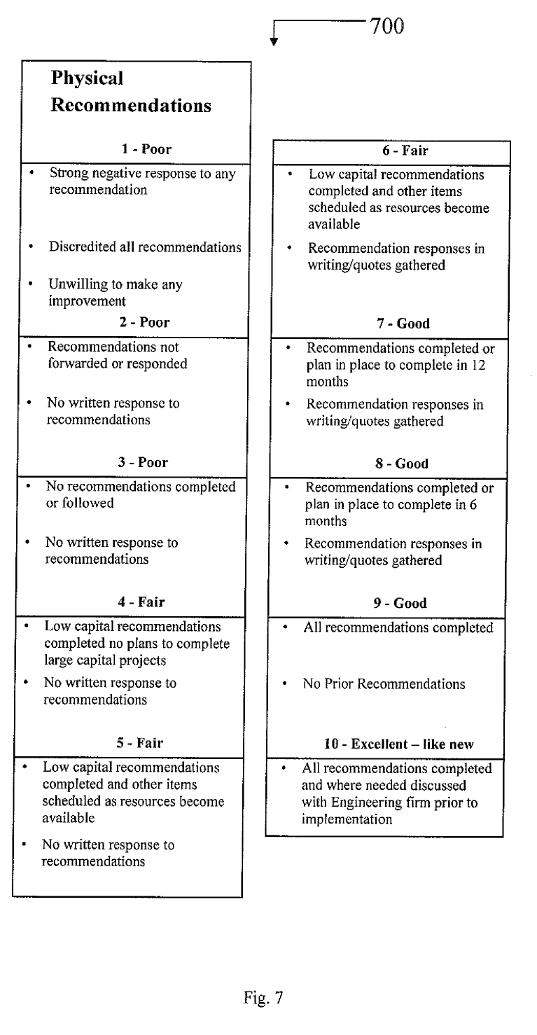

Referring now to FIG. 7, there is illustrated an exemplary physical protection 534 risk of loss assessment matrix 700, utilized to further assess the management team overseeing Area(N) of Property. More specifically, matrix 700 preferably is utilized to assess management's willingness and/or diligence in implementing recommended risk of loss physical recommendations in Areas(N) under evaluation in step 350 of process 300. Upon completing the assessment utilizing the Objective Factors in matrix 700, the next step is to insert the objectively determined numerical value of Area(N) based on matrix 700, into row 5 of FIG. 5. Preferably, matrix 700 is an objective physical protection risk of loss rating system, with descriptions for poor (1-3), fair (4-6), good (7-9), or excellent (10).

Next, construction 514 preferably has two criteria 530 illustrated as description of building 536 and new construction 538.

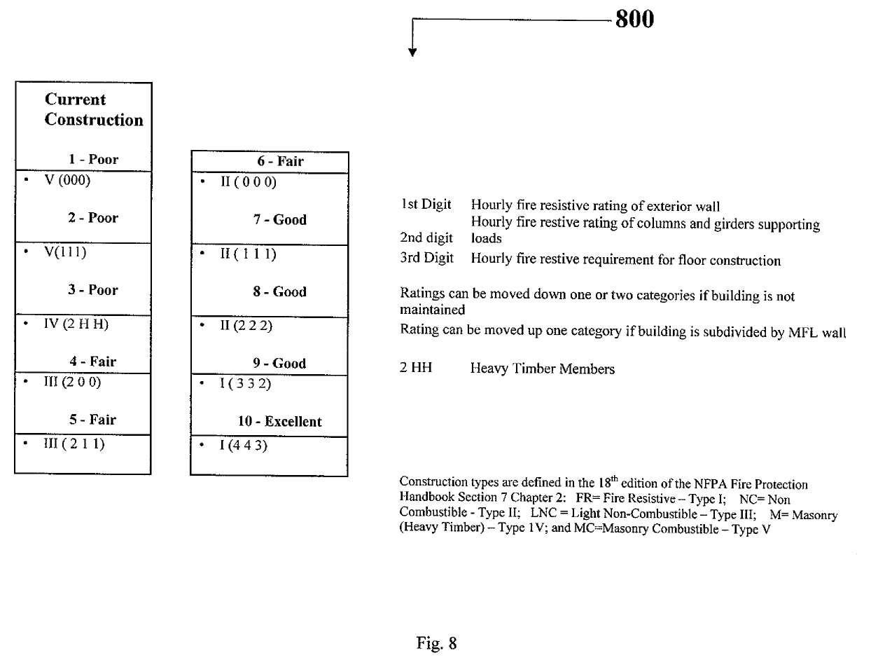

Referring now to FIG. 8, there is illustrated an exemplary description of building 536 risk of loss assessment matrix 800, utilized to assess the type of construction utilized in constructing Area(N) of Property. More specifically, matrix 800 preferably utilizes section 7 of Chapter 2 of the 18^{th} edition of the “NFPA Fire Protection Handbook” to define construction types and to assess construction 514 under evaluation in step 350 of process 300. Upon completing the assessment utilizing the Objective Factors in matrix 800, the next step is to insert the objectively determined numerical value of Area(N) based on matrix 800 into row 7 of FIG. 5. Preferably, matrix 800 translates the NFPA Fire Protection Handbook defined construction types into an objective risk of loss rating system for poor (1-3), fair (4-6), good (7-9), or excellent (10). For example, if Area (N) has a wall rating of ‘3’, a column rating of ‘3’ and a floor rating of ‘3’, then Area(N)'s [3,3,3] assessment translates, utilizing matrix 800, into a risk of loss rating of ‘9’, to be inserted into row 7 of FIG. 5.

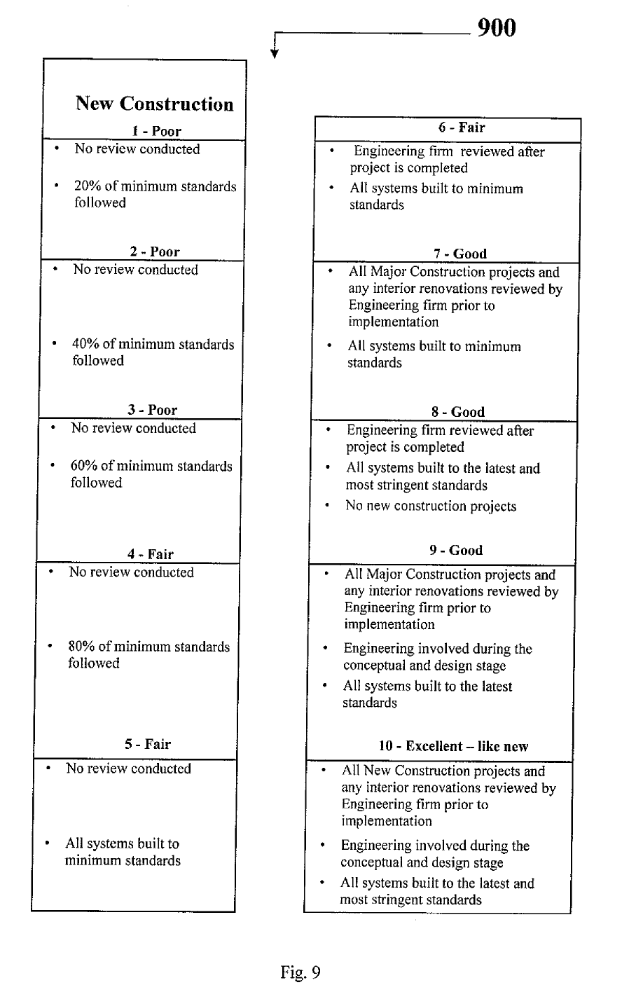

Referring now to FIG. 9, there is illustrated an exemplary new construction 538 risk of loss assessment matrix 900, utilized to assess the detail of the review process followed during Property construction. More specifically, matrix 900 preferably is utilized to assess the construction standards followed during construction, including, but not limited to certified architectural and engineering documents, third-party inspections during all phases of construction, construction code standards, documented signoffs and approvals and the like implemented during design and construction phases under evaluation in step 350 of process 300. Upon completing the assessment utilizing the Objective Factors in matrix 900, the next step is to insert the objectively determined numerical value of Area(N) based on matrix 900 into row 8 of FIG. 5. Preferably, matrix 900 is an objective new construction risk of loss rating system, with descriptions for poor (1-3), fair (4-6), good (7-9), or excellent (10).

Next, occupancy 516 preferably has two criteria 530 illustrated as process hazards 540 and storage hazards 538.

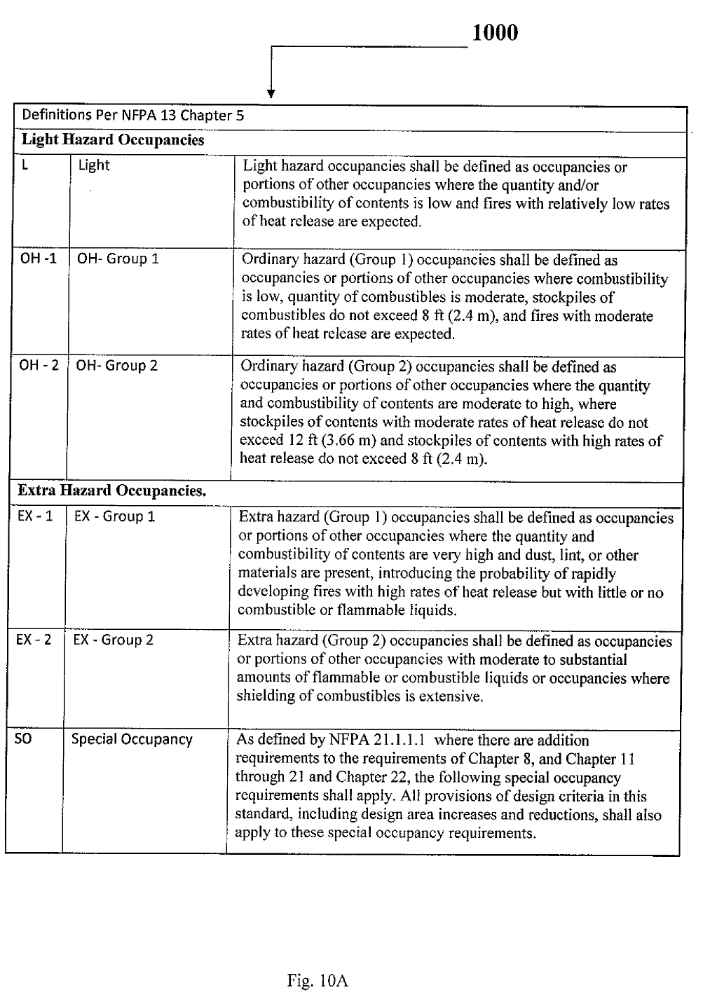

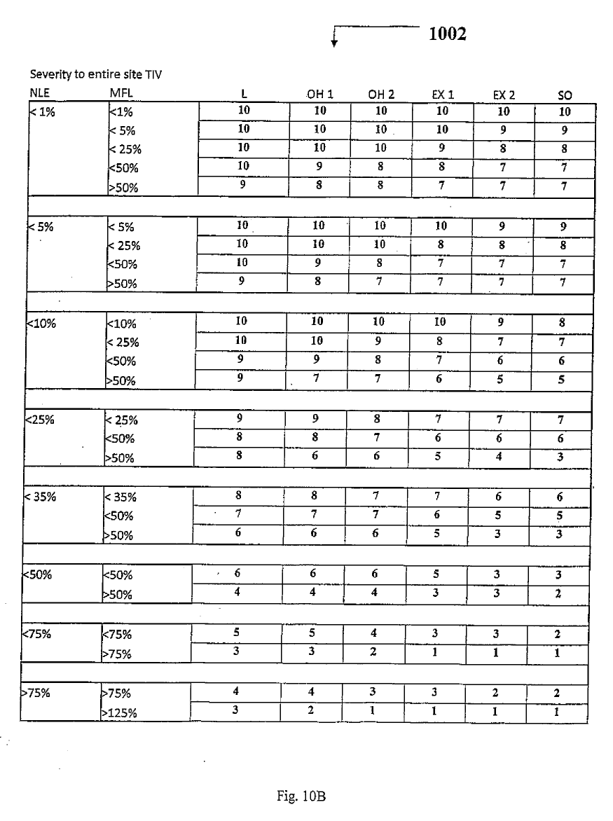

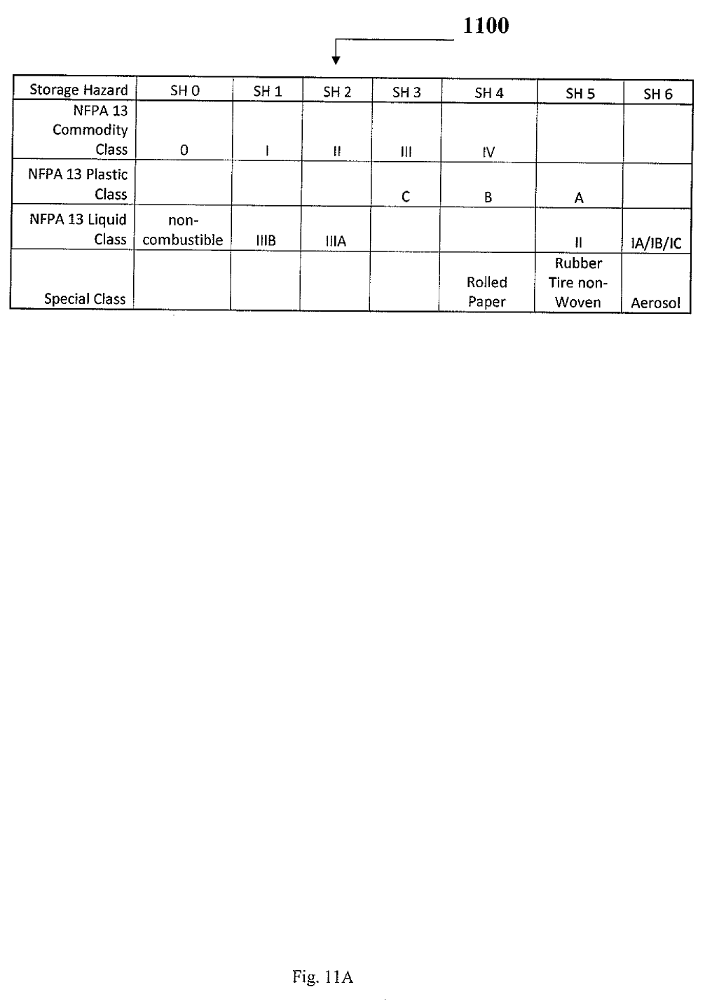

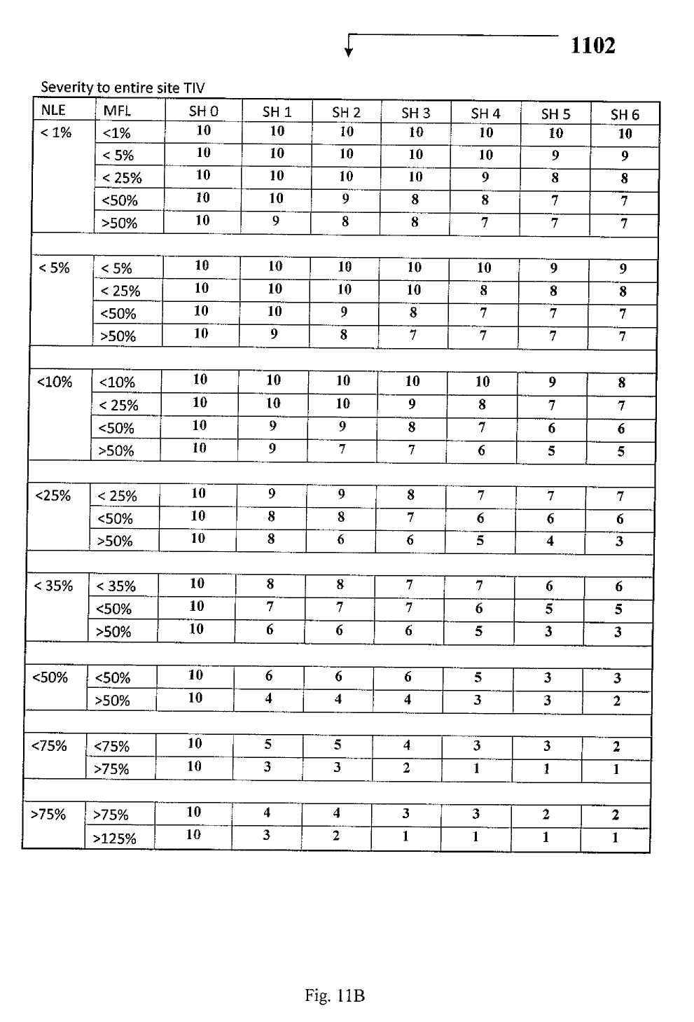

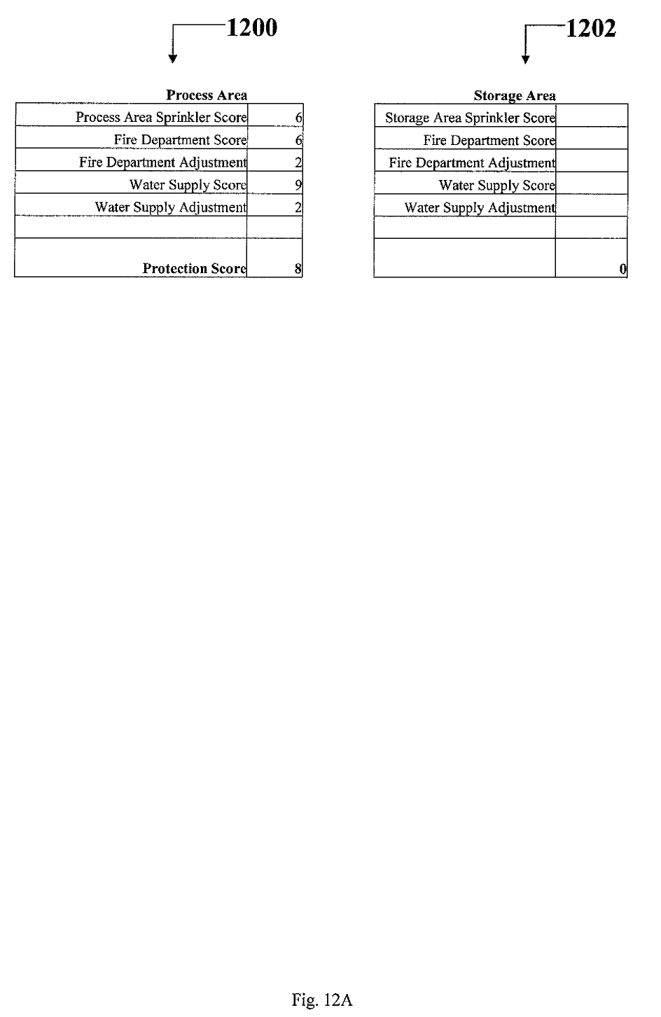

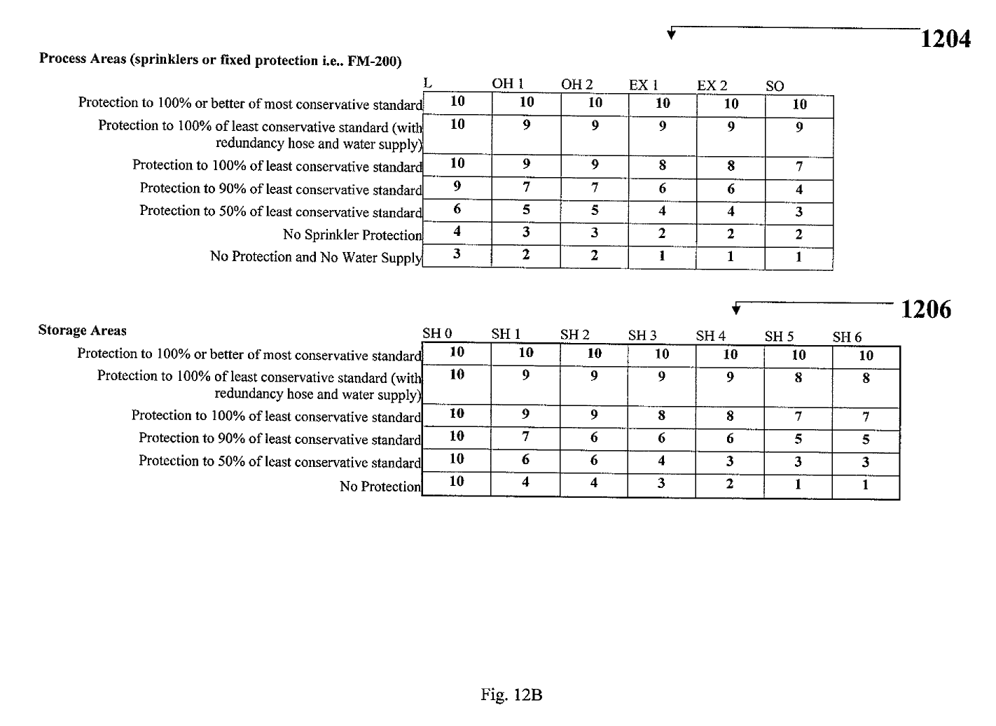

Referring now to FIG. 10A, there is illustrated exemplary definitions of process hazards 540 risk of loss assessment definitions 1000 utilized to assess the type of process hazard encountered in Area(N) of Property. More specifically, definitions 1000, preferably utilizes Paragraphs 5.2, 5.3, and 5.4 of “NFPA 13 Standard for the Installation of Sprinkler Systems 2007 Edition” to define hazard types as light, ordinary (groups 1&2) and extra hazard (groups 1&2). Moreover, a fifth special occupancy class is provided for those hazards that do not meet the definitions.

Referring now to FIG. 10B, there is illustrated an exemplary process hazard 540 risk of loss assessment matrix 1002, utilized to assess the severity and probability of a process hazard occurrence in Area(N) of Property. More specifically, matrix 1002 preferably is utilized to assess the probability of a process hazard based on Area(N)'s NLE percentage and MFL percentage, as well as classification under definitions 1000 (running across the top row of matrix 1002) to determine process hazard 540 risk of loss rating under evaluation in step 350 of process 300. Upon completing the assessment utilizing the Objective Factors in matrix 1002, the next step is to insert the objectively determined numerical value of Area(N) based on matrix 1002 into row 10 of FIG. 5. Preferably, matrix 1002 is an objective process hazard risk of loss rating system, with descriptions for poor (1-3), fair (4-6), good (7-9), or excellent (10). For example, Area(N) could be defined as a light hazardous (L) occupancy using FIG. 10A with an NLE (as defined above) of <1%, such as Area(N) has a sprinkler system and an MFL of 100% due to total failure of the sprinkler system and no fire department in the area. The probability risk of loss rating for Area(N) based on matrix 1002 is determined to be a ‘9’ and such number is to be inserted into row 10 of FIG. 5. An alternative evaluation could use the PML instead of the MFL for the evaluation.

Referring now to FIG. 11A, there is illustrated exemplary definitions of storage hazards 542 risk of loss assessment definitions matrix 1100, utilized to assess the type of storage hazard encountered in Area(N) of Property. More specifically, definitions matrix 1100 preferably utilizes NFPA 13 Standard for the Installation of Sprinkler Systems 2007 Edition.

Paragraphs 5.6.3, 5.6.4 define hazard types as storage hazards by Commodity Class I to IV, three plastic classes (A, B, C) and NFPA 30 Flammable and Combustible Liquids Code 2008 Edition paragraph 4.3 to define flammable liquids types(IA, IB, IC, II, IIIA, IIIB). These classes along with other special storage classes and the like are reclassified into seven storage hazard types (SH0, SH1, SH2, SH3, SH4, SH5, and SH6).

Referring now to FIG. 11B, there is illustrated an exemplary storage hazard 542 risk of loss assessment matrix 1102 utilized to assess the severity and probability of a storage hazard occurrence in Area(N) of Property. More specifically, matrix 1102 preferably is utilized to assess the probability of a storage hazard based on Area(N)'s NLE percentage and MFL percentage, as well as classification under definitions 1100 (running across the top row of matrix 1102) to determine storage hazard 542 risk of loss rating under evaluation in step 350 of process 300. Upon completing the assessment utilizing the Objective Factors in matrix 1102 the next step is to insert the objectively determined numerical value of Area(N) based on matrix 1102 into row 11 of FIG. 5. Preferably, matrix 1102 is an objective process hazard risk of loss rating system, with descriptions for poor (1-3), fair (4-6), good (7-9), or excellent (10). For example, Area(N) could be a storage area for computers (Group C plastic) defined as storage hazard 3 (SH3) using FIG. 11A, with an NLE (as defined above) of <5% and an MFL of 100% based on no fire walls in a big open warehouse and no sprinklers functioning nor fire department. The probability risk of loss rating for Area(N) based on matrix 1102 is determined to be a 17′ and such number is to be inserted into row 11 of FIG. 5. An alternative evaluation could use the PML instead of the MFL for the evaluation.

Next, protection 518 preferably has three criteria 530, illustrated as fire protection 544, fire equipment inspection 546 and surveillance 548.

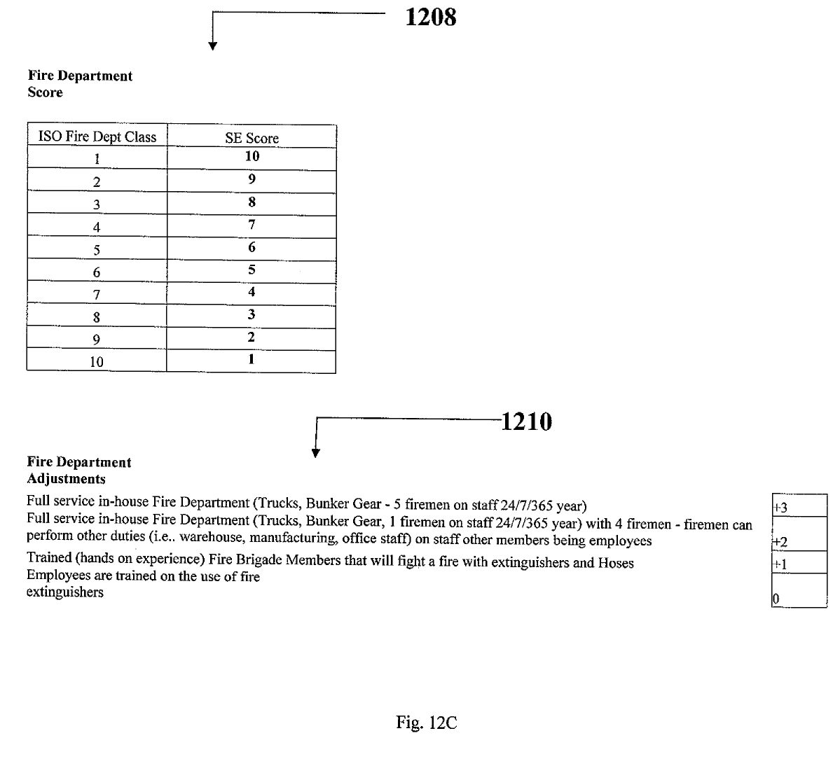

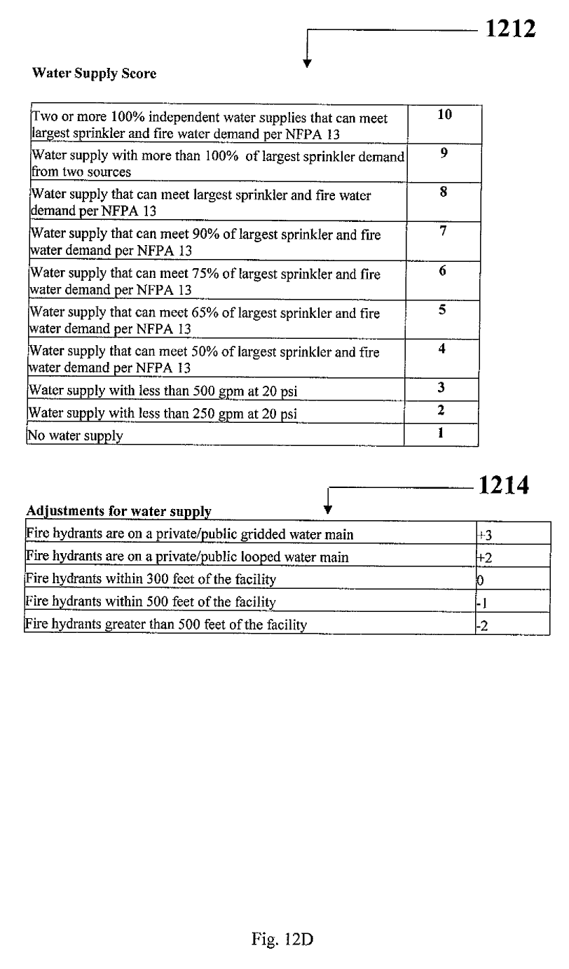

Referring now to FIG. 12A, there is illustrated an exemplary fire protection 544 risk of loss summary tables 1200 and 1202, utilized to assess the fire protection 544 risk of loss ratings for process hazard 540 of Area(N) and storage hazard 542 of Area(N), respectively, by summarizing and averaging the risk of loss rating determined in FIGS. 12B, C and D to determine an average fire protection 544 risk of loss rating for Area(N) under evaluation in step 350 of process 300. Upon completing the assessment utilizing the Objective Factors in matrix 1200 or 1202 the next step is to insert the objectively determined numerical value of Area(N) based on table 1200 into row 13 of FIG. 5. Preferably, summary tables 1200 and 120 are objective fire protection risk of loss rating systems, with descriptions for poor (1-3), fair (4-6), good (7-9), or excellent (10).

Referring now to FIG. 12B, there is illustrated an exemplary fire protection 544 risk of loss assessment matrix 1204, utilized to assess process areas sprinklers and fixed fire protection systems, and risk of loss assessment matrix 1206, utilized to assess storage areas sprinklers and fixed fire protection systems protection capabilities in Area(N) of Property. More specifically, matrix 1204 preferably is utilized to assess the sprinklers and fixed fire protection systems based on an evaluation of Area(N)'s sprinklers and/or fixed fire protection systems, as well as classification under definitions 1000 (running across the top row of matrix 1204) to determine process hazard 540 risk of loss rating. Still further, matrix 1206 preferably is utilized to assess the sprinklers and fixed fire protection systems based on an evaluation of Area(N)'s sprinklers and/or fixed fire protection systems, as well as classification under definitions 1100 (running across the top row of matrix 1206) to determine storage hazard 542 risk of loss rating.

Referring now to FIG. 12C, there is illustrated an exemplary fire protection 544 risk of loss assessment matrix 1208, utilized to assess local fire department capabilities serving Area(N) of Property. More specifically, matrix 1208 preferably is utilized to assess the local fire department capabilities based on the departments Insurance Services Office (ISO) rating, which can be determined by phoning the local fire department. Based on the local fire departments ISO rating, the fire protection 544 risk of loss rating can be obtained utilizing matrix 1208. Moreover, the fire protection 544 risk of loss rating is adjusted based on internal fire protection services and training utilizing matrix 1210. More specifically, matrix 1208 preferably is utilized to assess the type of internal fire brigade capabilities, staffing and training of Area(N) based on assessment definitions matrix 1210. Based on the internal fire brigades fire protection 544, risk of loss adjustment can be obtained utilizing matrix 1210. The risk of loss adjustment is added to risk of loss rating obtained using matrix 1208.

Referring now to FIG. 12D, there is illustrated an exemplary fire protection 544 risk of loss assessment description matrix 1212, utilized to assess internal water supply capabilities serving Area(N) of Property. More specifically, matrix 1212 preferably is utilized to assess the internal water supply capabilities based on the requirements as defined for the specific occupancy per the National Fire Protection Agency. Based on the definition that best describes the internal water supply capabilities, the fire protection 544 risk of loss rating can be obtained utilizing matrix 1212. Moreover, the fire protection 544 risk of loss rating is adjusted based on local community water supply utilizing matrix 1214. More specifically, matrix 1214 preferably is utilized to assess the distance between Area(N) and the nearest public fire hydrants based on assessment definitions matrix 1214. Based on the water supply fire protection 544, risk of loss adjustment can be obtained utilizing matrix 1214. The risk of loss adjustment is added to the risk of loss rating obtained using matrix 1212 under evaluation in step 350 of process 300.

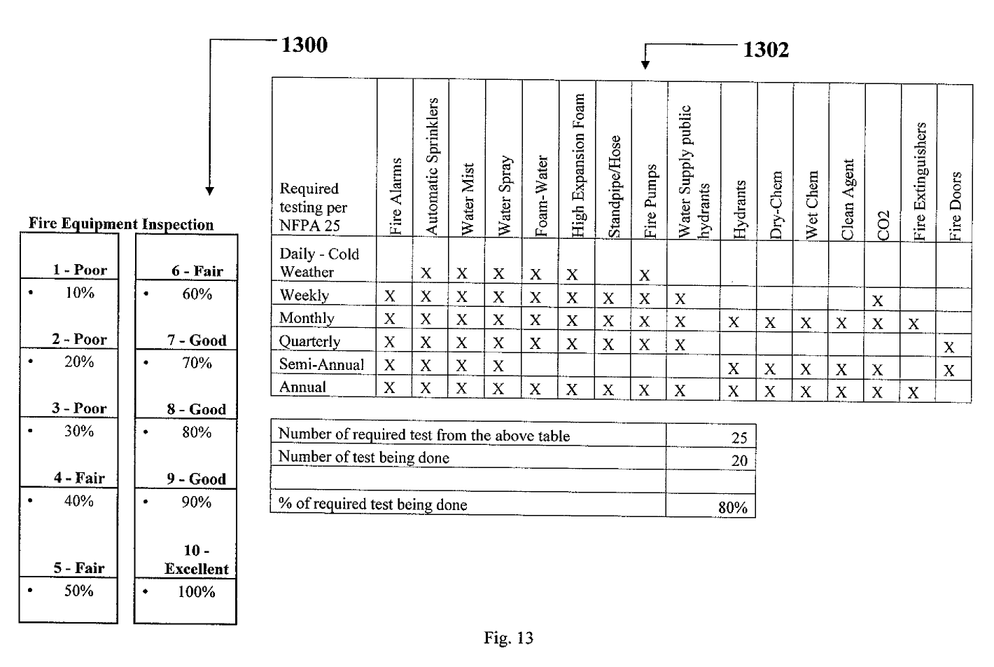

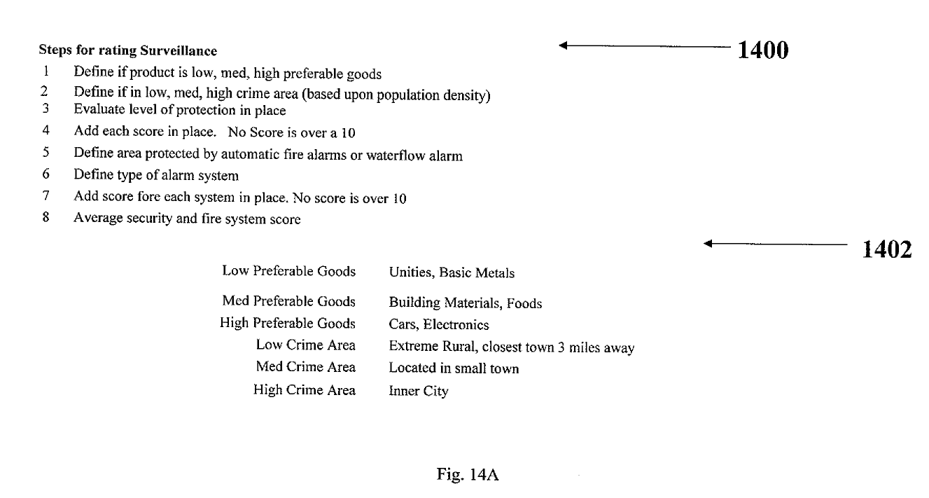

Referring now to FIG. 13, there is illustrated an exemplary fire equipment inspection 546 risk of loss assessment matrix 1300 and 1302, utilized to assess fire equipment inspection procedures and frequency of such inspections of Area(N) of Property. More specifically, matrix 1302 preferably is utilized to assess the number of fire protection systems defined in NFPA-25 “Standard for the Inspection, Testing, and Maintenance of Water-Based Fire Protection Systems, 2008 Edition” or its current edition and shown as column headers in matrix 1302. An Evaluator counts the number of fire protection systems defined in NFPA-25, which are located in Area(N) and divides this number by the total number of fire protection systems defined in NFPA-25, which defines a percentage. Such percentage is input into matrix 1300, wherein a fire equipment inspection 546 risk of loss rating is obtained utilizing matrix 1300 for Area(N) under evaluation in step 350 of process 300. Upon completing the assessment utilizing the Objective Factors in matrix 1300, the next step is to insert the objectively determined numerical value of Area(N) based on matrix 1300 into row 14 of FIG. 5. Preferably, summary tables 1300 and 1302 are objective fire equipment inspection risk of loss rating systems, with descriptions for poor (1-3), fair (4-6), good (7-9), or excellent (10).

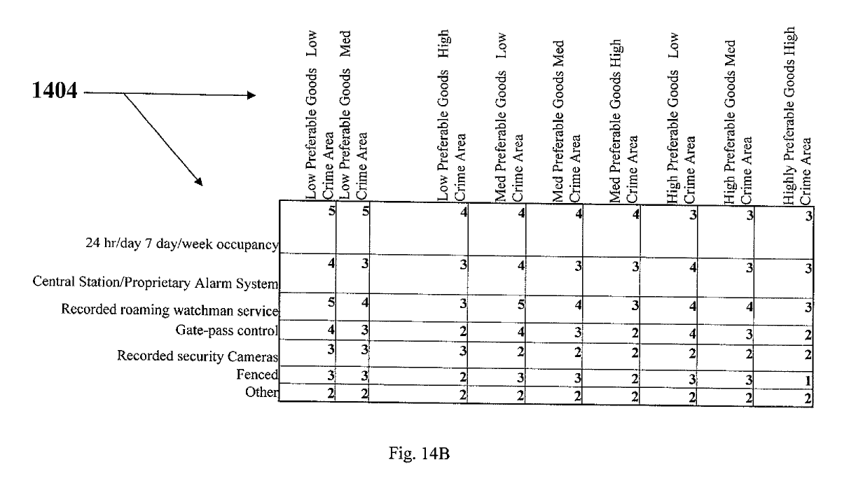

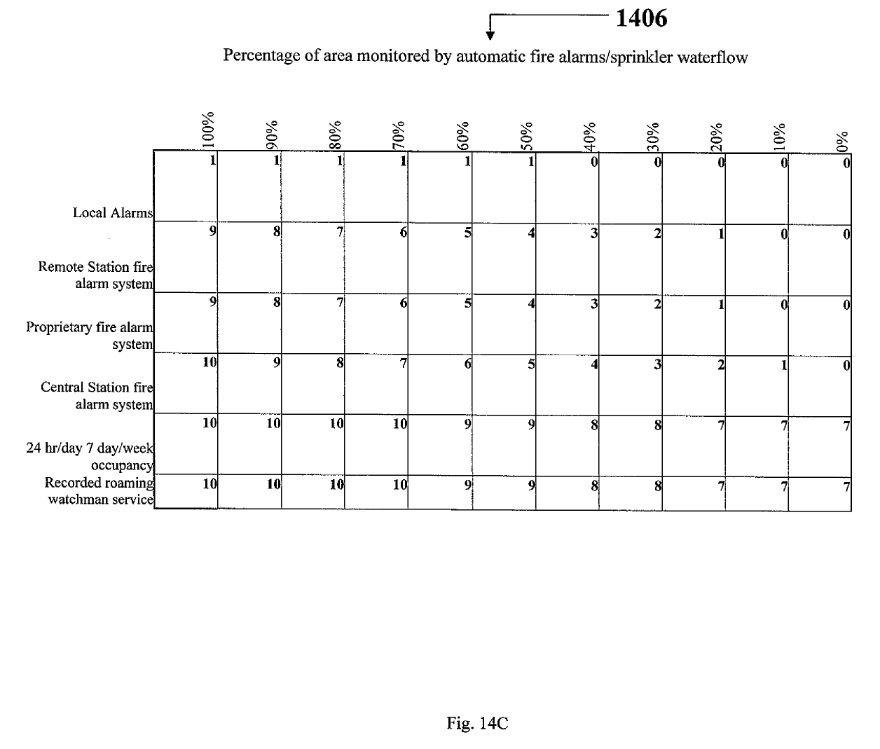

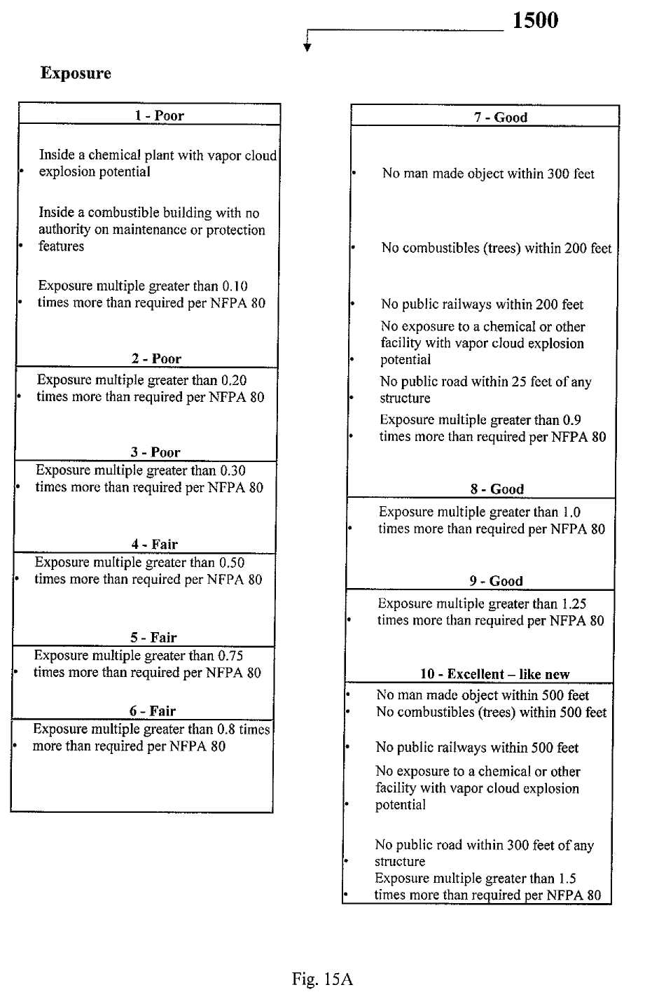

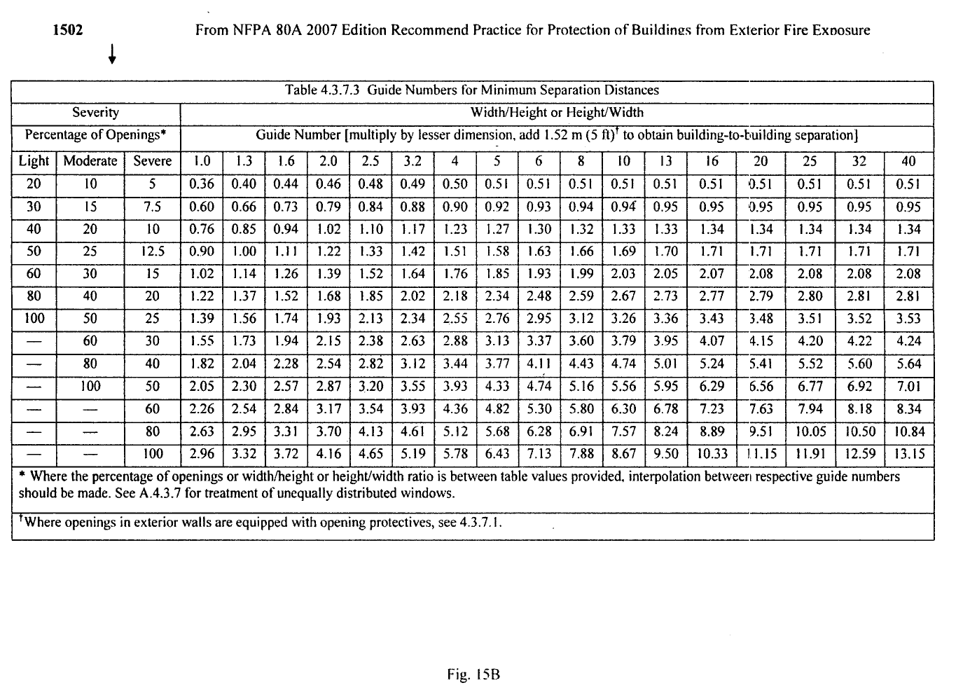

Referring now to FIG. 14, there is illustrated an exemplary surveillance 548 risk of loss assessment process 1400, goods and crime area classification 1402, and automatic fire alarms/sprinkler matrix 1404, utilized to assess the surveillance requirements or systems in place at Area(N) of Property. More specifically, process 1400 preferably is utilized to define the steps in obtaining a surveillance risk of loss rating. In step 1 of process 1400, the goods located in Area(N) are classified based on the definitions of goods in classification 1402. Next, in step 2 of process 1400, the crime area in which Area(N) is located is determined based on the definitions in classification 1402. Next, in step 3 of process 1400, the surveillance system(s) in use at Area(N) are determined. Next, in step 4 of process 1400, matrix 1404 is utilized to determine the surveillance risk of loss rating for Area(N) of Property. The column headers of matrix 1404 are differing combinations of the goods and crime area classification 1402 and row headers are different levels of surveillance systems available to survey an area such as Area(N) of Property.

Based on the surveillance system(s) in use at Area(N) and goods and crime area classification 1402 of Area(N) one or more matrix 1404 numbers are selected. Such numbers are added together to determine the surveillance 548 risk of loss rating for Area(N) under evaluation in step 350 of process 300. Upon completing the assessment utilizing the Objective Factors in matrix 1402 and 1404, the next step is to insert the objectively determined summary numerical value of Area(N) based on matrix 1400 into row 15 of FIG. 5. Preferably, classification 1402 and matrix 1404 are objective surveillance risk of loss rating systems and descriptions for poor (1-3), fair (4-6), good (7-9), or excellent (10). For example, Area(N) could be a storage area for computers defined as ‘highly preferable goods’, Area(N) is located in a ‘high crime area’, and Area(N) has a ‘central alarm system’, ‘cameras’, and a ‘fence’, which utilizing matrix 1404 produces 3,2,1. The derived numbers are added together 3+2+1=6, whereby the probability risk of loss rating is ‘6’ to be placed in row 15 of FIG. 5.

Next, exposure 520 preferably has two criteria 530 illustrated as fire exposure 550 and perils other than fire 552.

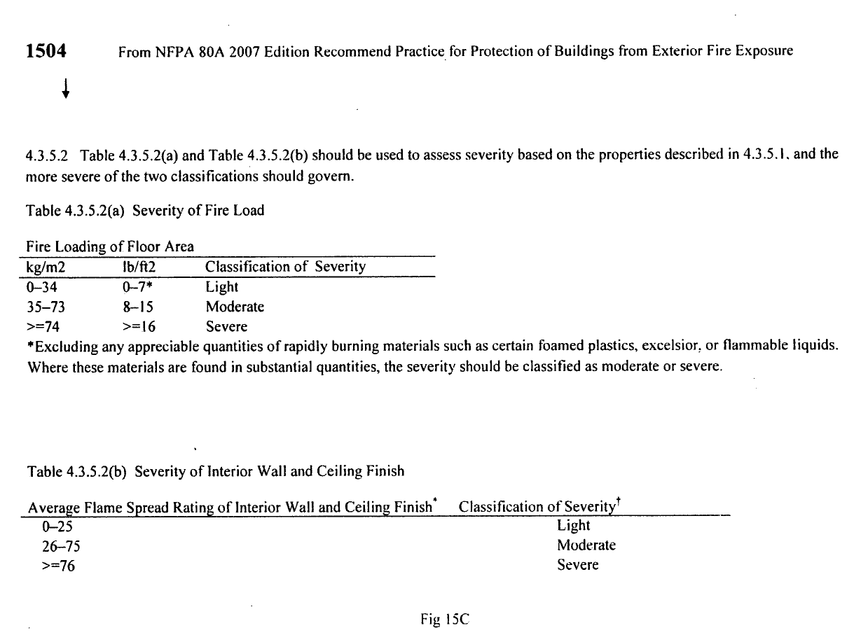

Referring now to FIG. 15, there is illustrated an exemplary fire exposure 550 risk of loss assessment matrix 1500, utilized to assess the fire exposure between two adjacent areas, Area(1) and Area(2), of Property due to their proximity to each other and combustible materials therein. First, Area(N) is evaluated utilizing matrix 1504 in FIG. 15C to determine the ‘severity of fire load’ for Area(N), whether ‘light’, ‘moderate’, or ‘severe’, and to determine the ‘severity of interior wall and ceiling finish’ for Area(N), whether ‘light’, ‘moderate’, or ‘severe’. Next, Area(N) is evaluated utilizing matrix 1502 in FIG. 15B to determine the recommended minimum separation distance between Area(1) and Area(2) of Property. The preferred distance between Area(1) and Area(2) is determined by multiplying the building-to-building separation ratio times the height of the highest building in Area(1) and Area(2) of Property. The number from matrix 1502 in FIG. 15B is used as a denominator and the actual distance between buildings between Area(1) and Area(2) of Property is the numerator. Such numerator and denominator make a fraction and this fraction is utilized in risk of loss assessment matrix 1500 to determine the fire exposure 548 risk of loss rating for Area(N) under evaluation in step 350 of process 300. The next step is to insert the objectively determined numerical value of Area(N), based on matrix 1500, into row 17 of FIG. 5.

Preferably, matrix 1500 is an objective fire exposure risk of loss rating system for poor (1-3), fair (4-6), good (7-9), or excellent (10). For example, Area(N) could be classified as ‘light severity’ in matrix 1504 in FIG. 15C, wherein Area(N) has a 100% glass siding, and the ratio of square footage of glass ‘2.0’, and then the building-to-building separation ratio is determined to be 1.93. Next, the denominator is calculated as 1.93×height of building in Area(N). If the denominator from the previous calculation is 400 and the numerator is 200 (based on the actual building-to-building separation distance between buildings in Area(1) and Area(2) of Property), then the ratio between the Areas(N) is 0.5. Next, utilizing matrix 1500, the example produces a fire exposure risk of loss rating of ‘4’ to be place in row 1711 of FIG. 5

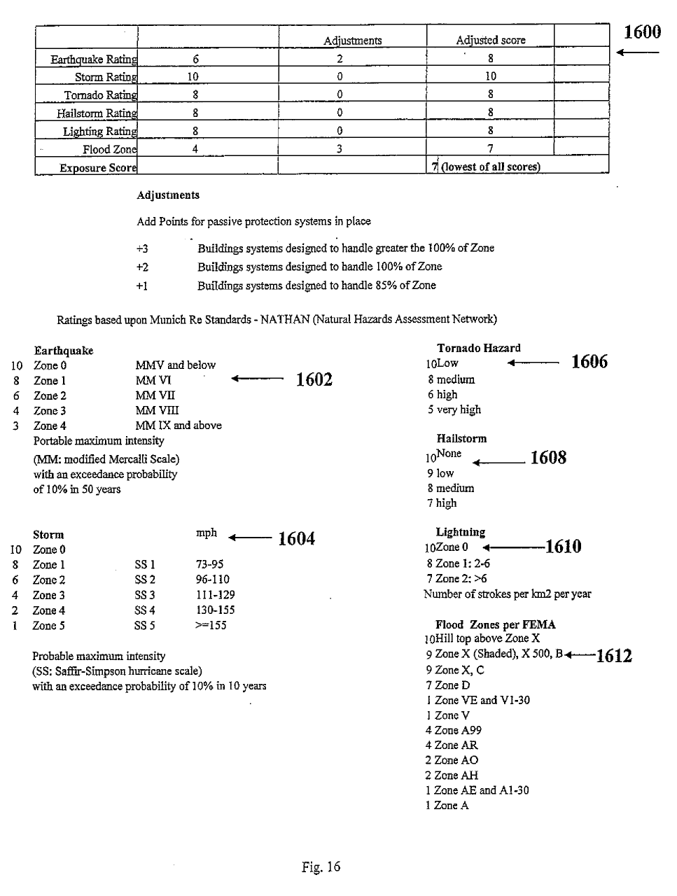

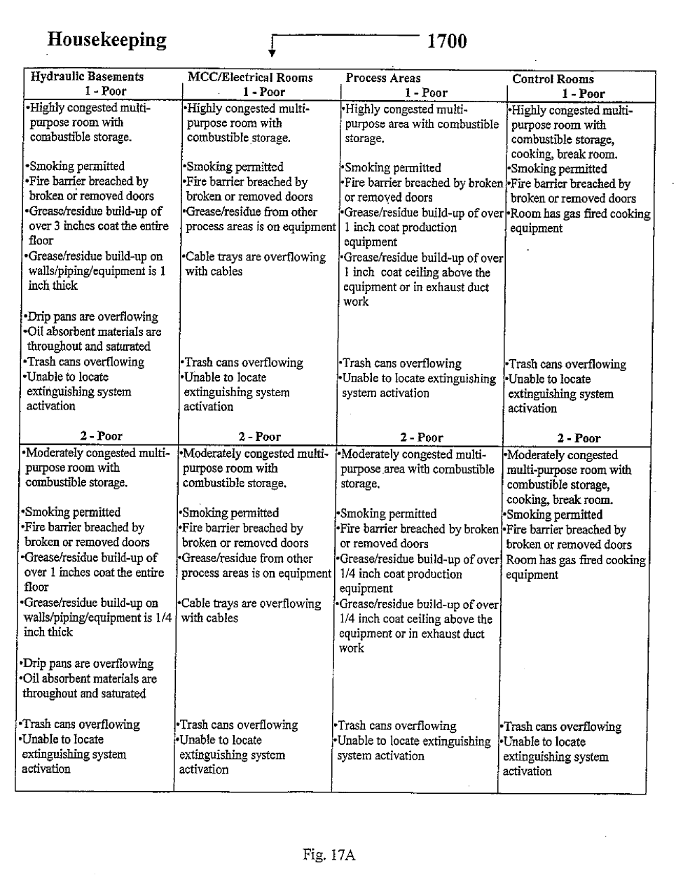

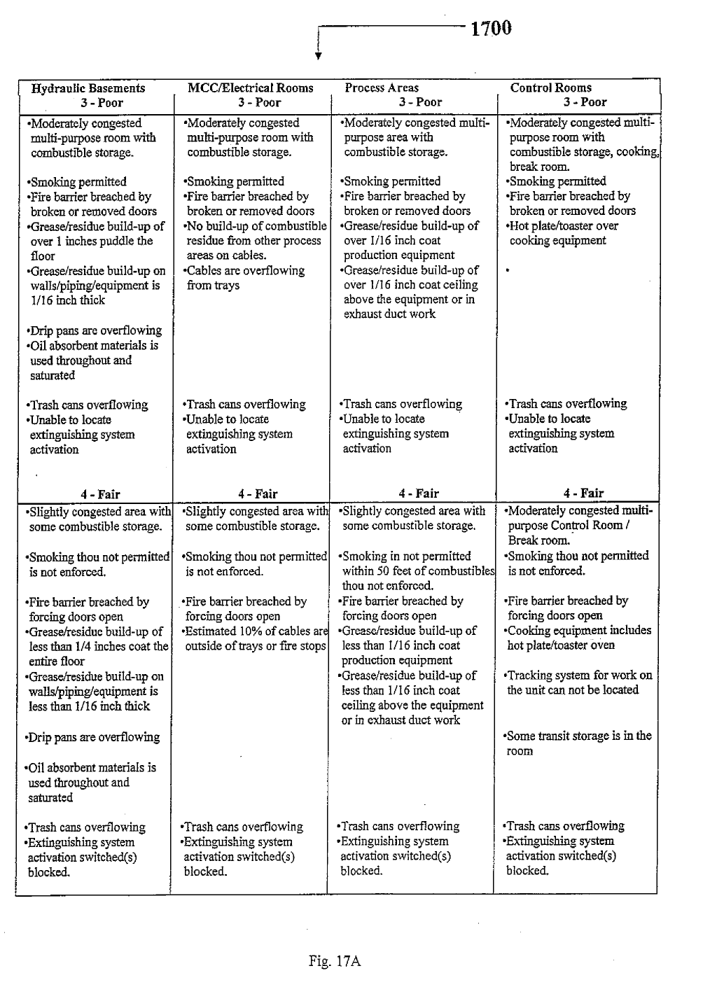

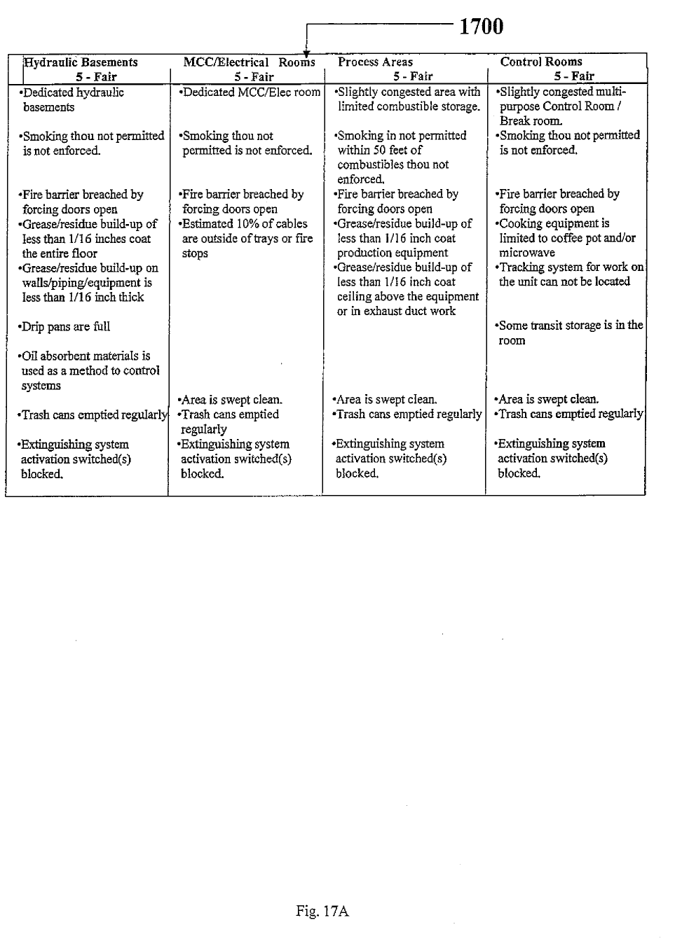

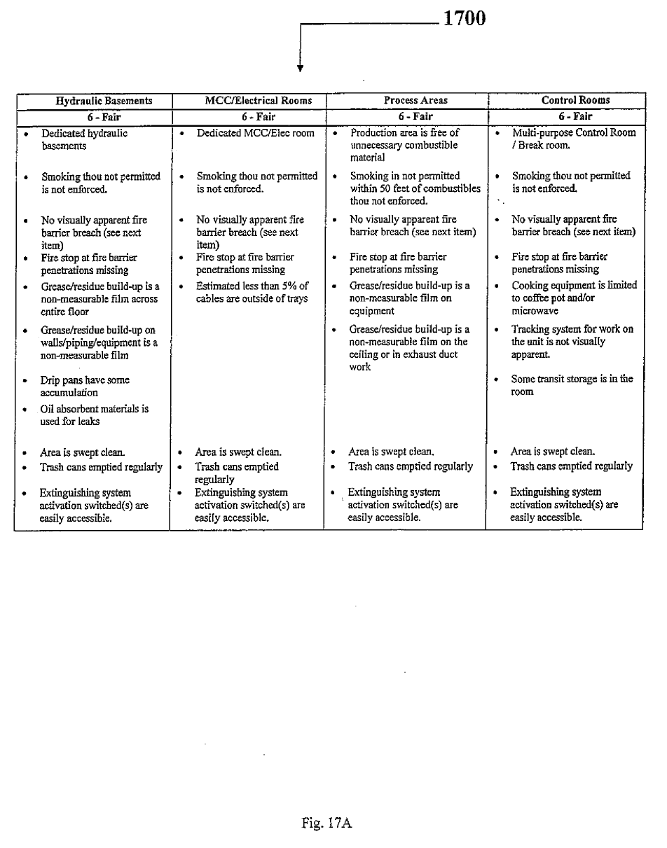

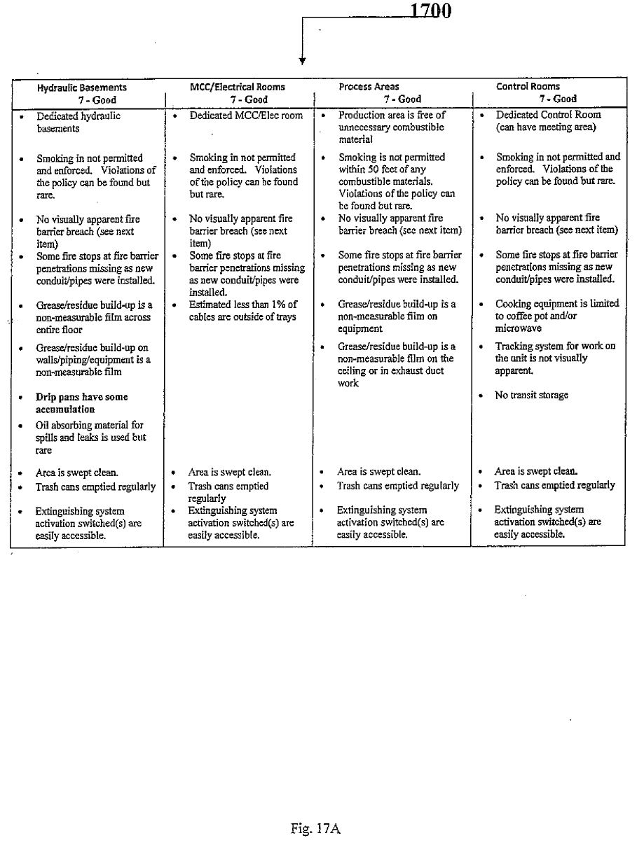

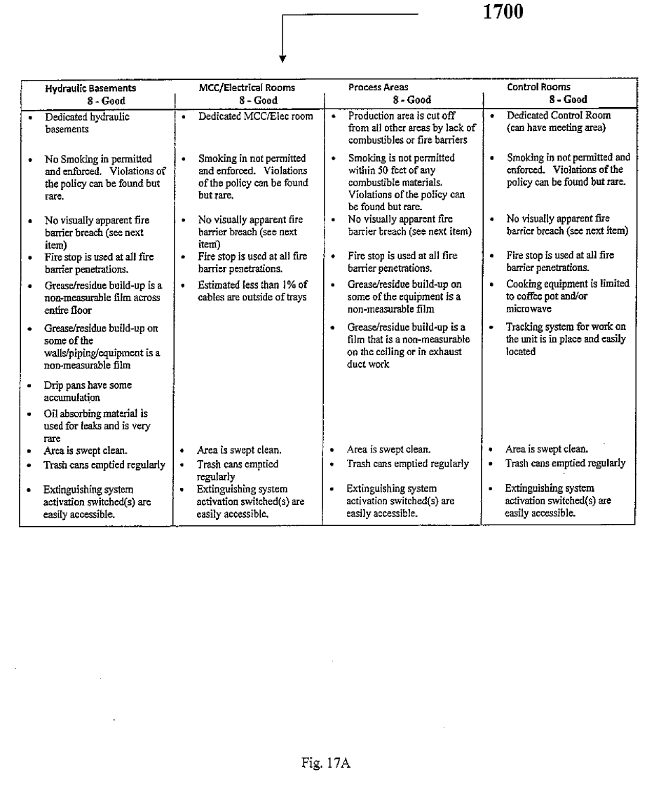

Referring now to FIG. 16, there is illustrated an exemplary description of perils other than fire 552 risk of loss assessment matrix 1600, utilized to assess risk of loss from perils other than fire for Area(N) of Property. More specifically, table 1600 preferably utilizes Munich Re Standards—NATHAN (Natural Hazards Assessment Network) to define other perils such as earthquake 1602, storm 1604, tornado 1606, hail 1608, lightning 1610, flood 1612 and the like. Each peril rating for Area(N) of Property whether by zone or severity level may be obtained by evaluating a map point for Area(N) of Property and therefrom determining the zone or severity level of each peril. Such numbers are utilized to fill in table 1600. Next, adjustments to each peril are determined utilizing adjustments 1614, wherein adjustments recognize when building systems are designed to exceed zone or severity requirements. The zone or severity level of each peril is added to its applicable adjustments to arrive at the adjusted score. Next, the lowest adjusted score is utilized to determine perils other than fire 552 risk of loss rating for Area(N) under evaluation in step 350 of process 300. Upon completing the assessment utilizing the Objective Factors in table 1600, the next step is to insert the objectively determined numerical value of Area(N) based on table 1600 into row 18 of FIG. 5. Preferably, classifications 1602 through 1614 and table 1600 are objective perils other than fire risk of loss rating systems, with descriptions for poor (1-3), fair (4-6), good (7-9), or excellent (10).

Next, management program 522 preferably has ten criteria 530, illustrated as housekeeping 554, impairment procedures 556, smoking regulations 558, maintenance 560, employee training 562, pre-emergency plan 564, hot work 566, contractors 568, management of change 570, and self inspection 572.

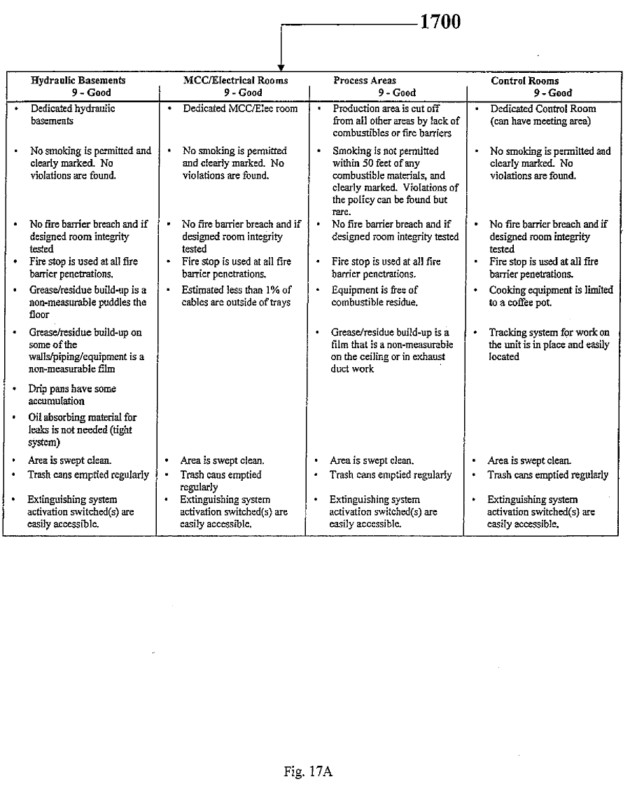

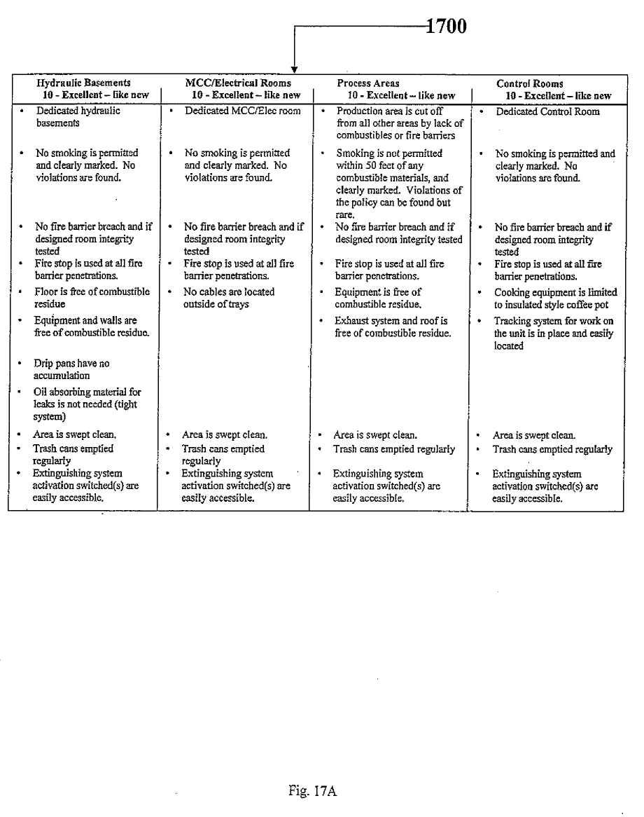

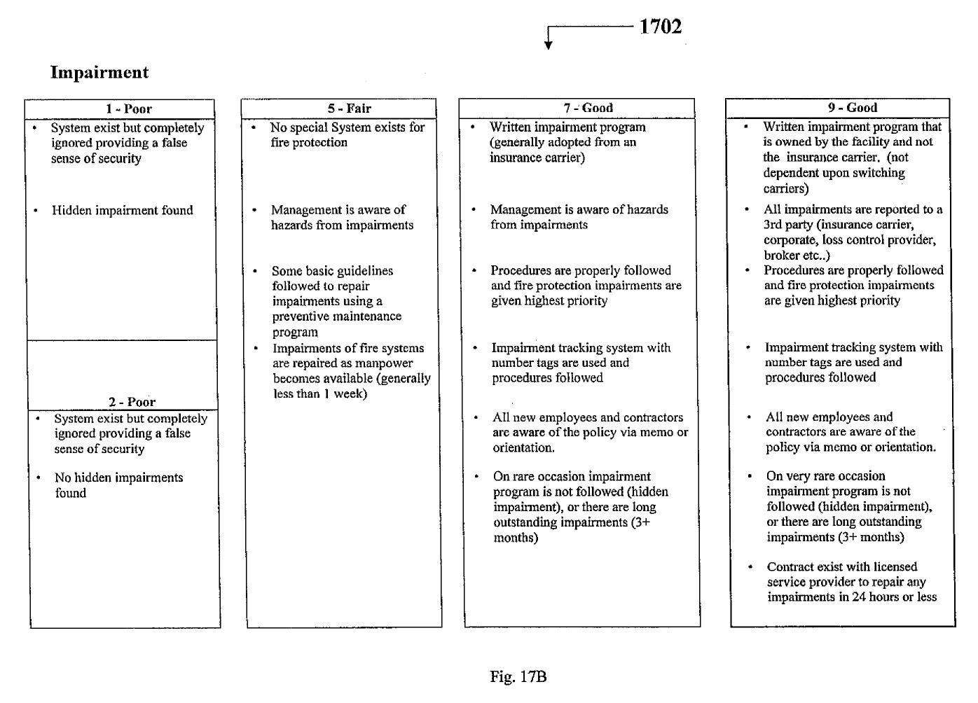

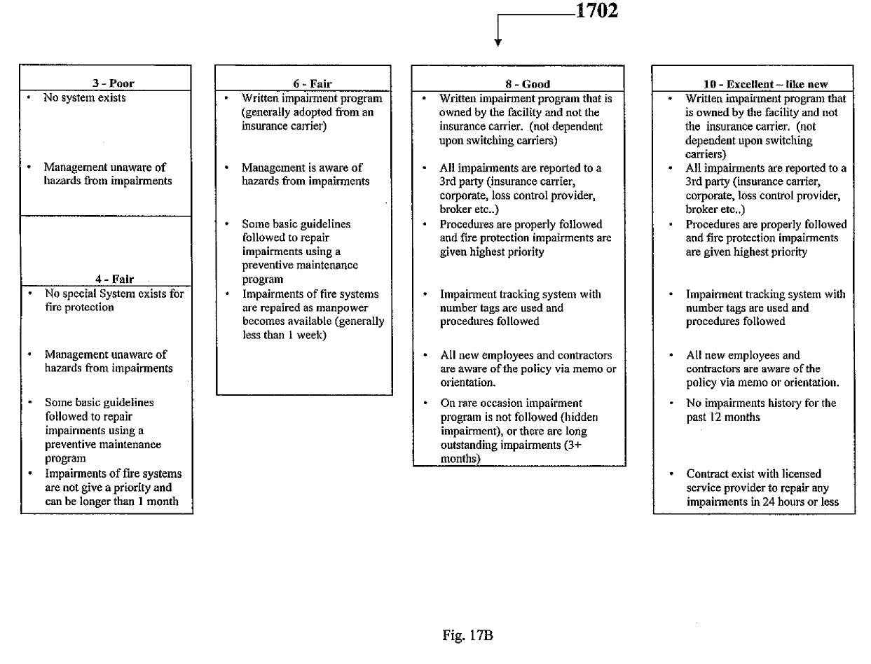

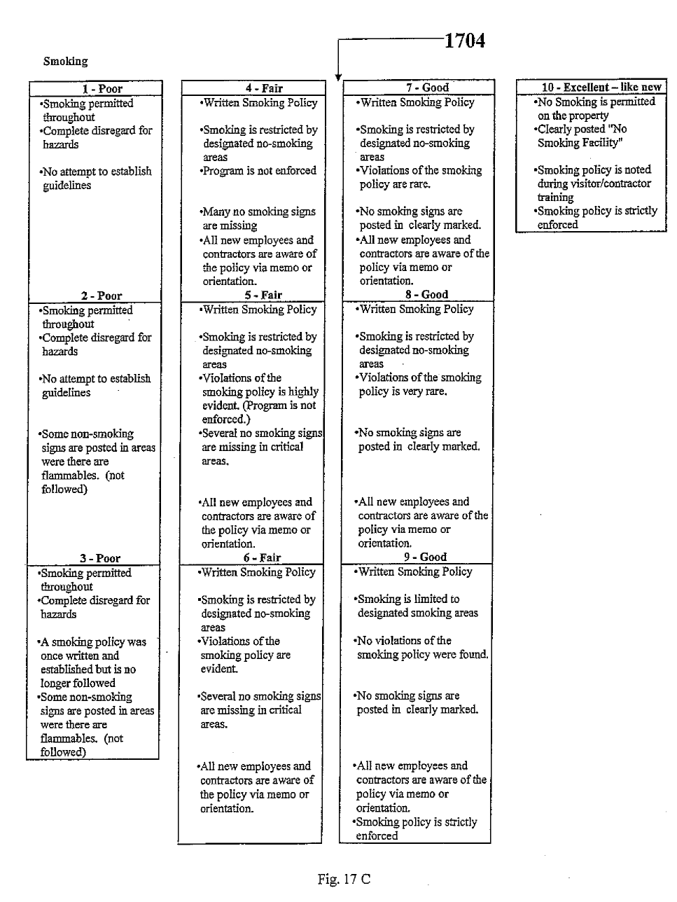

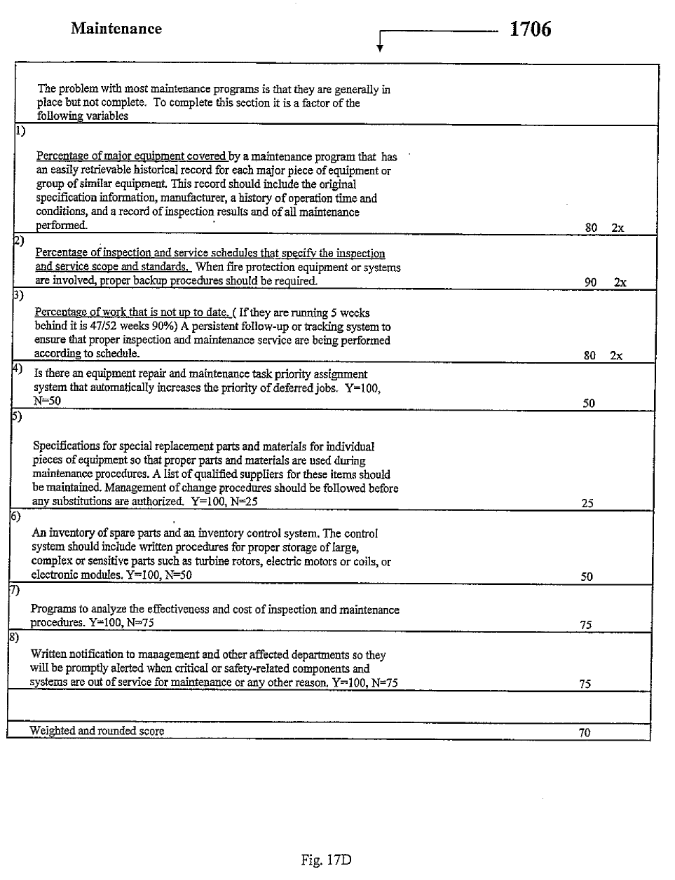

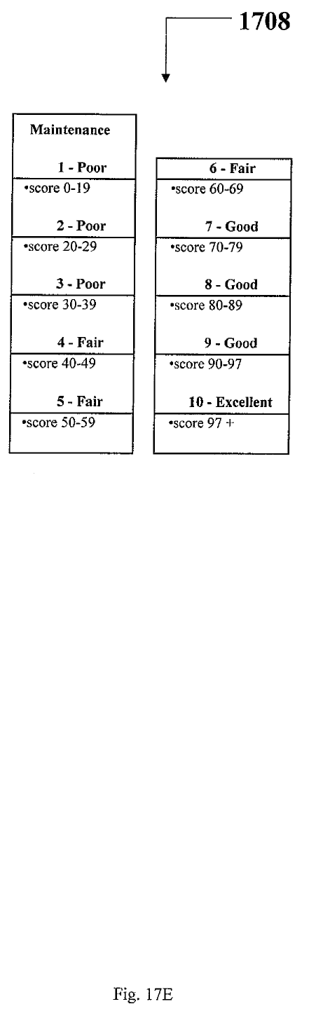

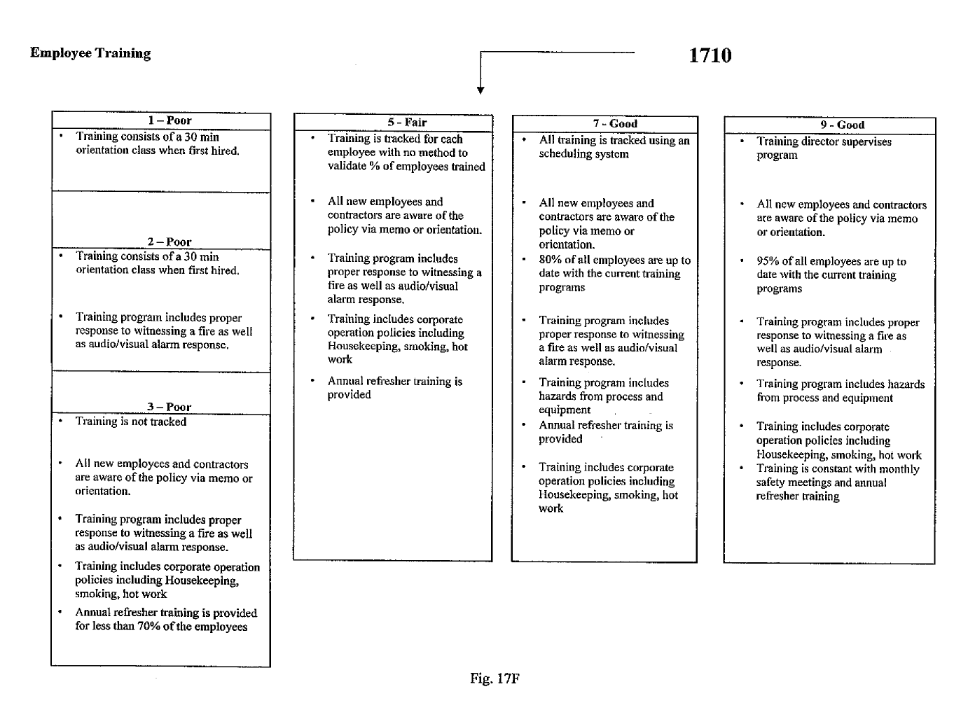

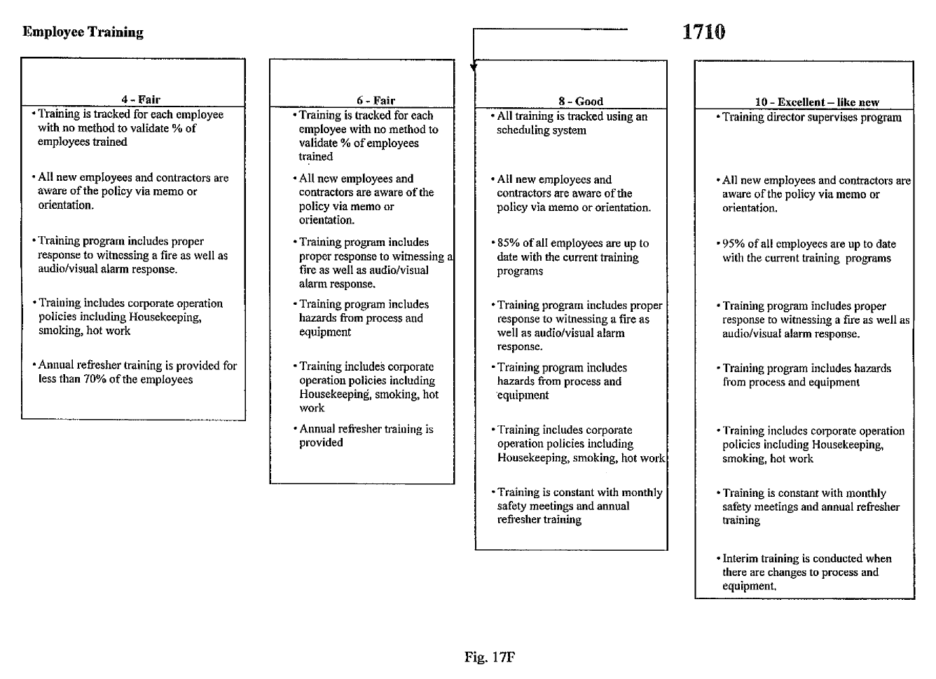

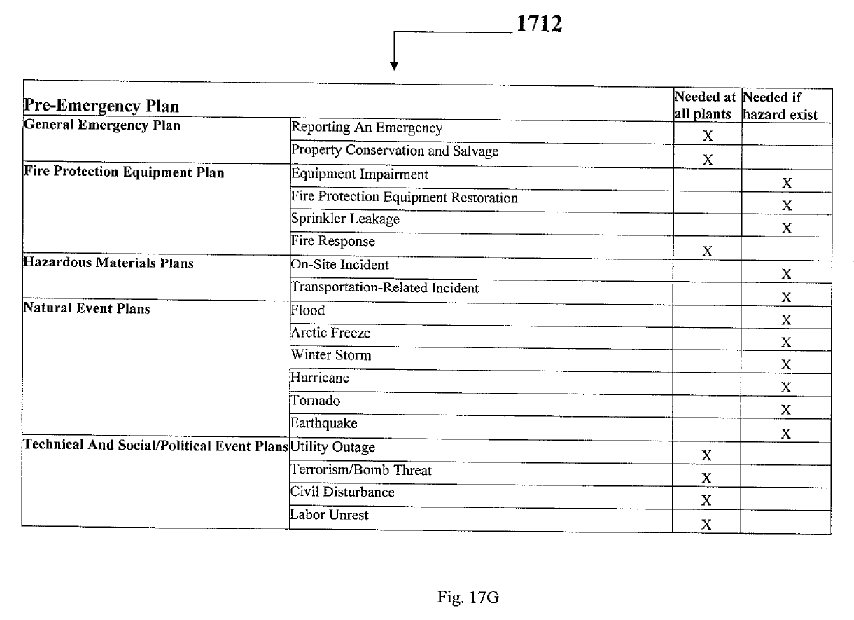

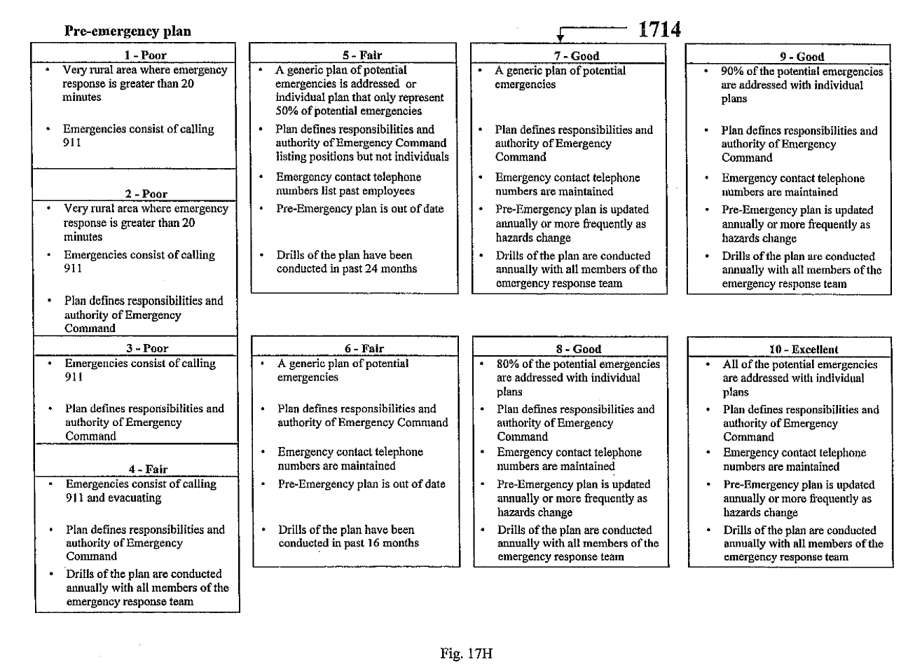

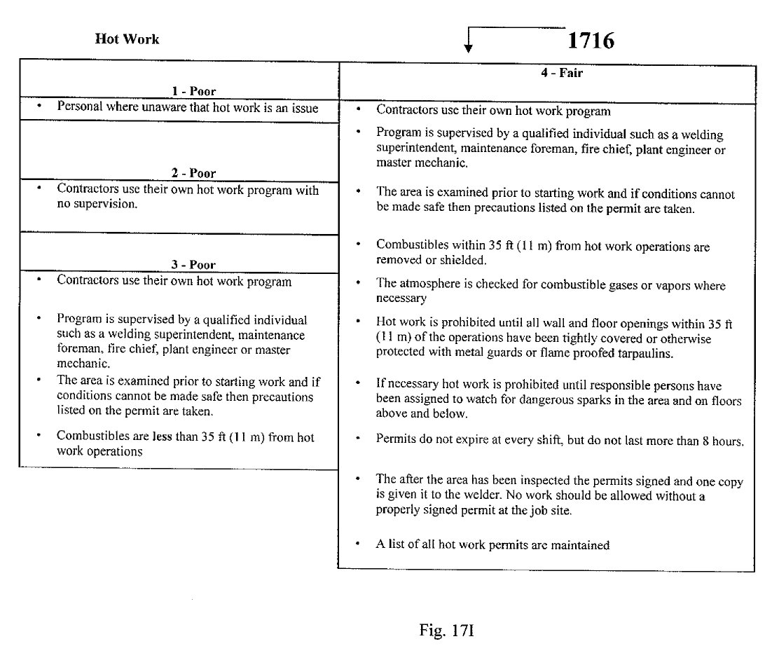

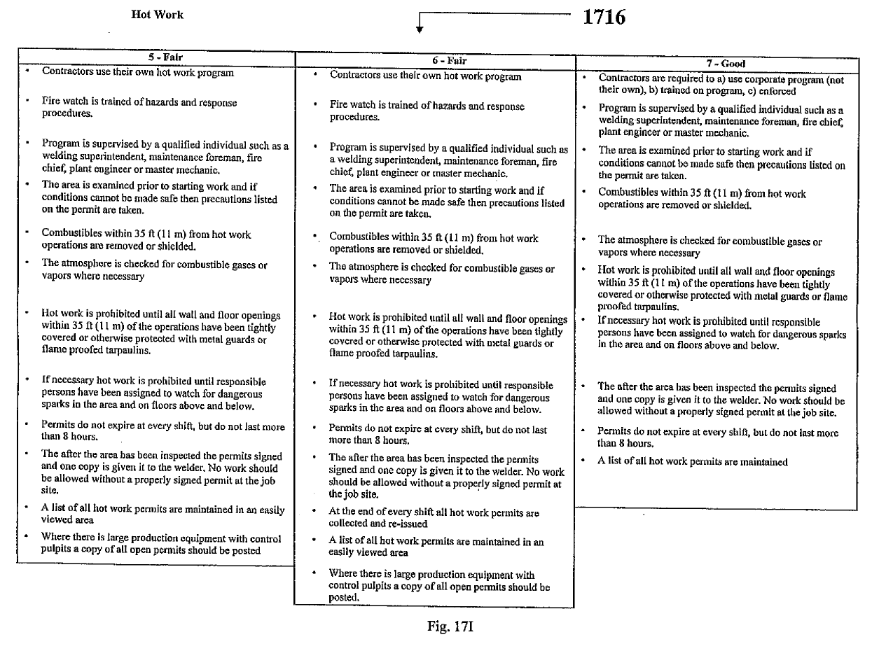

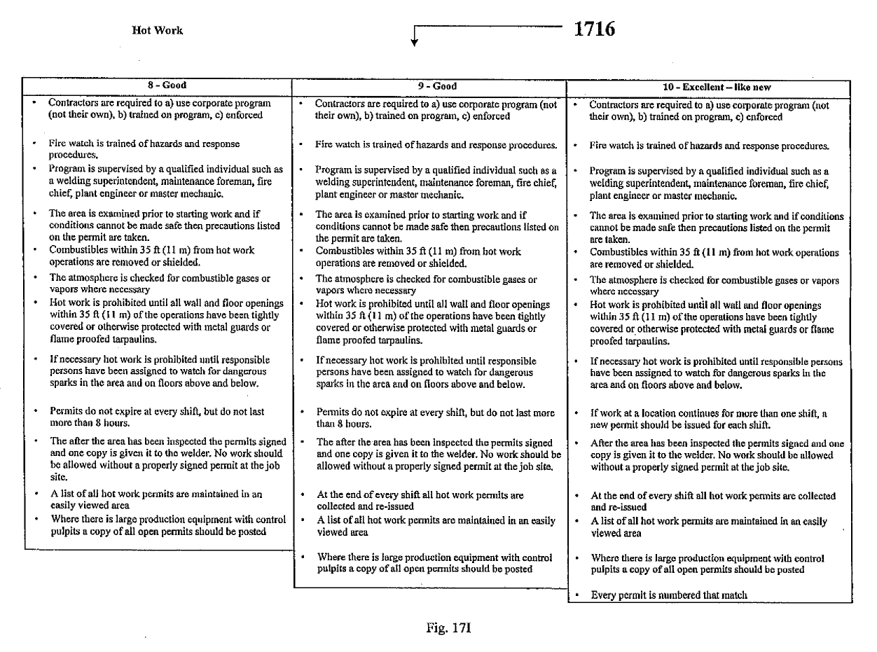

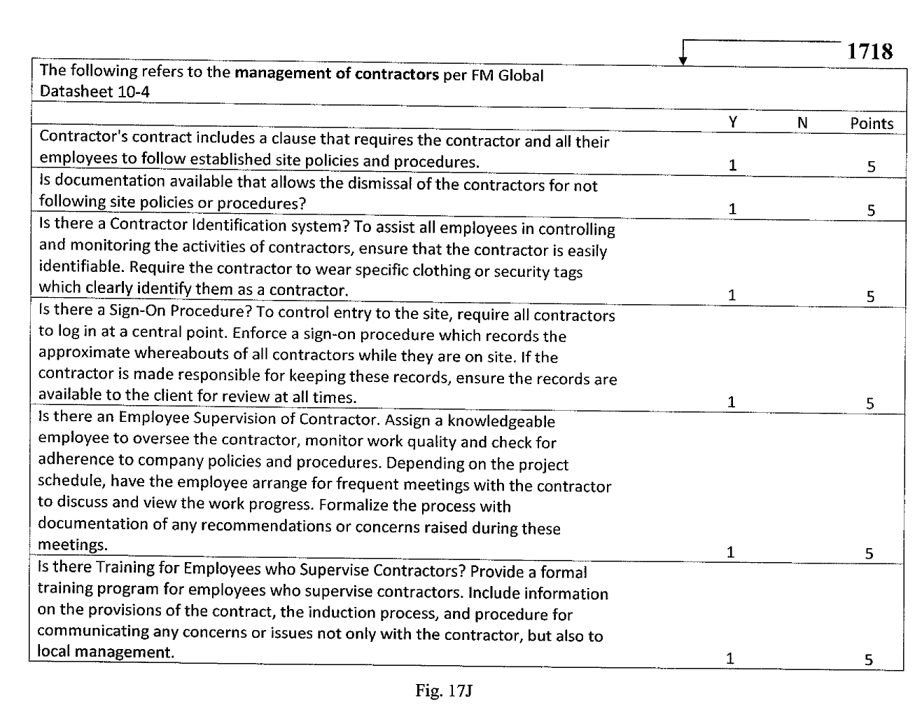

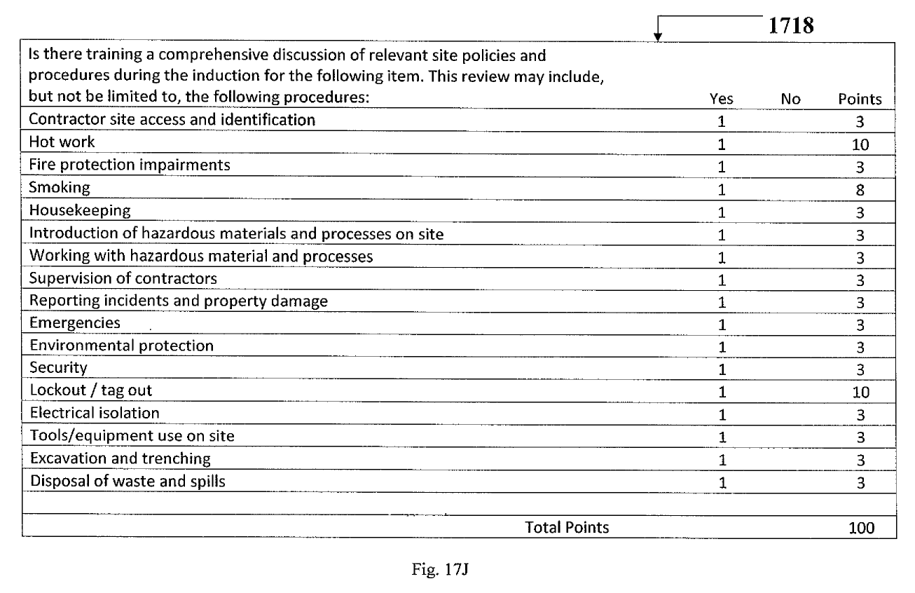

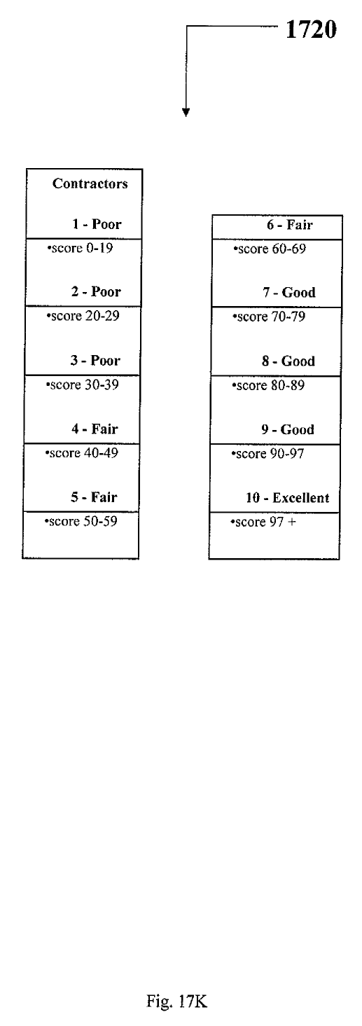

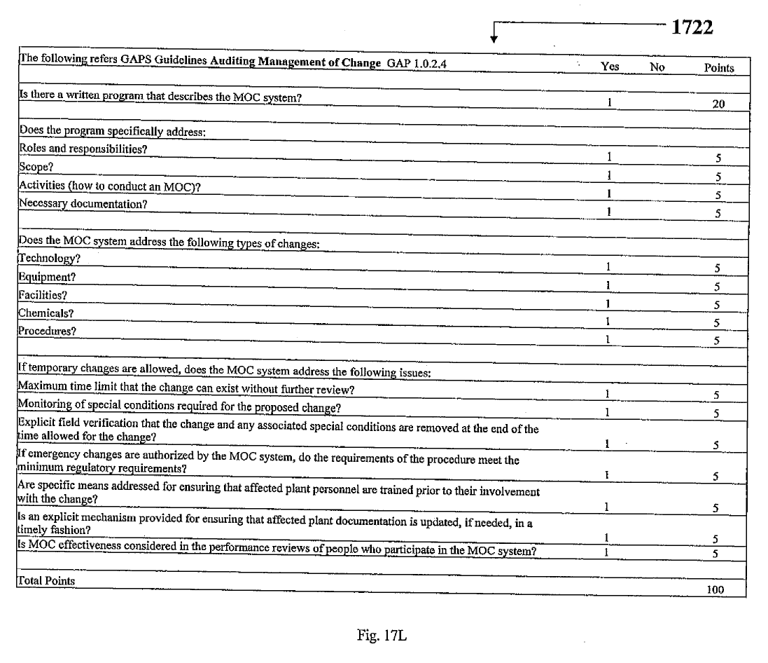

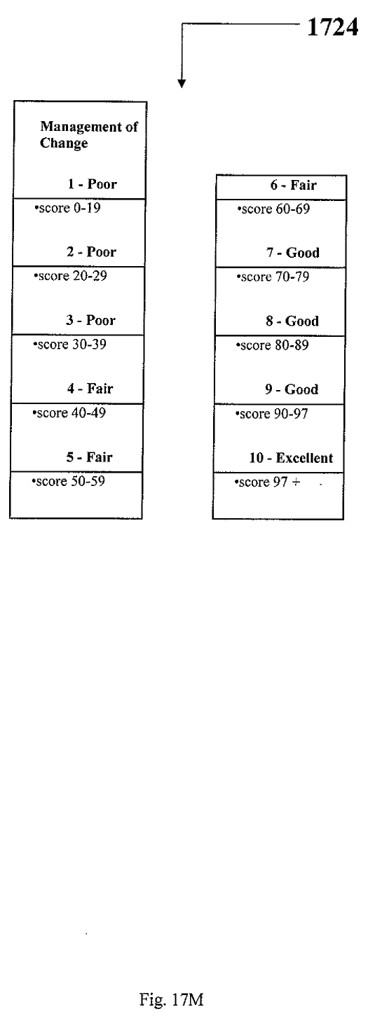

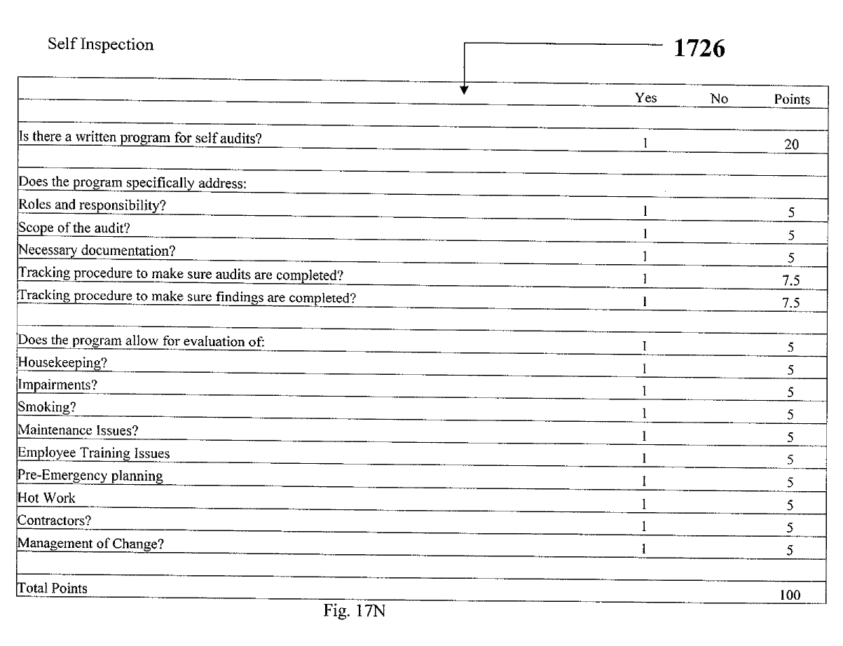

FIGS. 17A-17O represent an exemplary embodiment of the matrix for Criteria(Y), setting forth the Objective Factors required to objectively assess the risk of loss of management programs 522. It is contemplated herein that other representative matrix may be developed setting forth the Objective Criteria for assessing Criteria(Y) for housekeeping 554, impairment procedures 556, smoking regulations 558, maintenance 560, employee training 562, pre-emergency plan 564, hot work 566, contractors 568, management of change 570, and self inspection 572.

Still referring to FIG. 17, there is illustrated, exemplary management program 522, for exemplary house keeping 554 risk of loss assessment matrix 1700 utilized to assess congestion, combustible materials, basic fire protection equipment and smoking procedures of Area(N) of Property. More specifically, matrix 1700 preferably is utilized to assess management programs 522 for various sub-areas within Area(N) of Property, including but not limited to, hydraulic basements, MCC/electrical rooms, and process areas and the like under evaluation in step 350 of process 300. Upon completing the assessment utilizing the Objective Factors in matrix 1700 of FIGS. 17A-17O the next step is to insert the objectively determined numerical value of Area(N) based on matrix 1700 into row 20 of FIG. 5. Preferably, matrix 1700 is an objective exemplary house keeping 554 risk of loss rating system, with descriptions for poor (1-3), fair (4-6), good (7-9), or excellent (10).

It is contemplated herein that management program's 522 remaining nine criteria 530 illustrated as impairment procedures 556, smoking regulations 558, maintenance 560, employee training 562, pre-emergency plan 564, hot work 566, contractors 568, management of change 570, and self inspection 572 preferably have similar risk of loss assessment matrix as matrix 1702-1728 in FIGS. 17B-17O and such matrices are utilized to assess management program 522 under evaluation in step 350 of process 300. Upon completing the assessment utilizing the Objective Factors in such matrix the next step is to insert the objectively determined numerical values of Area(N) based on such applicable matrix 1702-1728, respectively into rows 21, 22, 23, 24, 25, 26, 27, 28, and 29, respectively of FIG. 5. Preferably, such matrix is an objective risk of loss rating system, with descriptions for poor (1-3), fair (4-6), good (7-9), or excellent (10).

Next, business continuity 524 preferably has two criteria 530, illustrated as utilities 574 and business continuity plan 576.

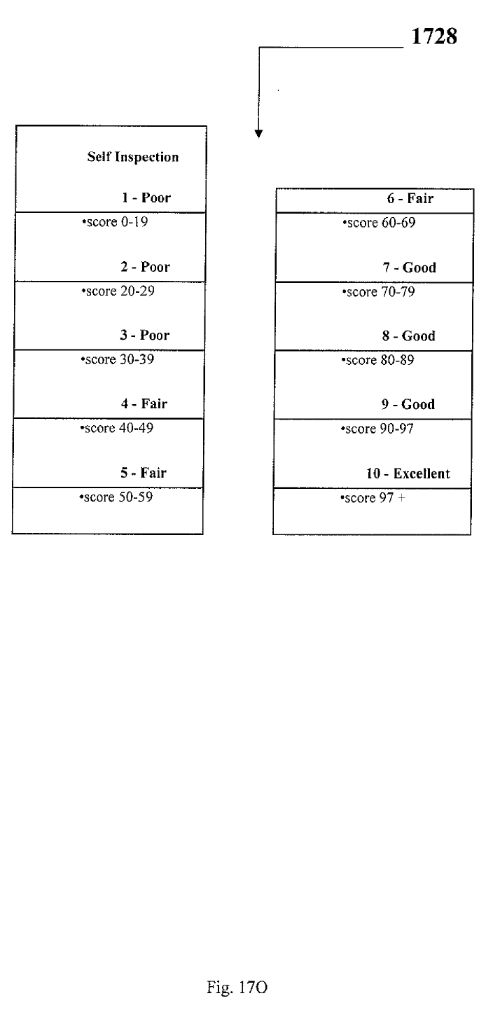

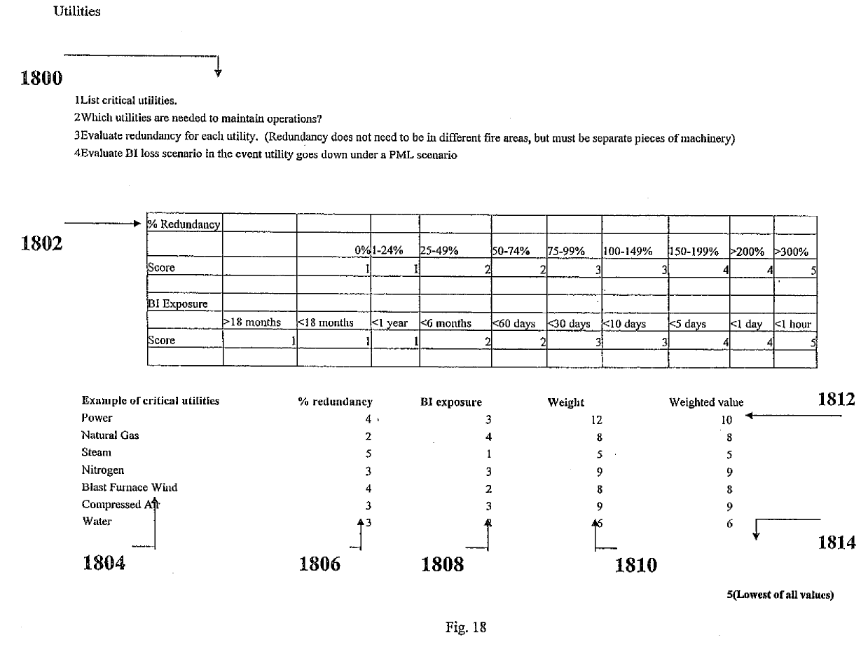

Referring now to FIG. 18, there is illustrated an exemplary utilities 574 risk of loss assessment process 1800, % redundancy and business interruption (BI) exposure scores 1802, and table 1804, utilized to assess the utilities required for operation of Area(N) of Property. More specifically, process 1800 preferably is utilized to define the steps in obtaining the critical utilities risk of loss rating. In step 1 of process 1800, utilities, such as electricity (power) gas, steam, gases like nitrogen, compressed air, water, and the like, which are located in Area(N) are listed in column 1 of table 1804. Next, in step 2 of process 1800, the listed utilities are identified as either critical or non-critical to maintaining operations in Area(N). Next, in step 3 of process 1800, % redundancy 1808 of each critical utility in Area(N) is determined under evaluation in step 350 of process 300. Next, in step 4 of process 1800, % BI exposure 1806 of each critical utility in Area(N) is determined under evaluation in step 350 of process 300. Such BI exposure 1806 and % redundancy 1808 are entered in column 2 and 3 of table 1804. Next, the entry in BI exposure 1806 is multiplied by the entry in % redundancy 1808 and the resulting number is entered in weight 1810 for each row.

Next, if the resulting number in weight 1810 is greater than or equal to 10, then ‘10’ is entered into weight tested 1812. Otherwise, the whole number 0-9 from weight 1810 is carried over and input into weight tested 1812. The lowest whole number 1814 under weight tested 1812 preferably is utilities 574 risk of loss rating for Area(N) under evaluation in step 350 of process 300. Upon completing the assessment utilizing the Objective Factors in process 1800 the next step is to insert the objectively determined numerical value of Area(N) based on table 1804 into row 31 of FIG. 5. Preferably, % redundancy and business interruption (BI) exposure scores 1802, and table 1804 are objective utilities 556 risk of loss rating system for poor (1-3), fair (4-6), good (7-9), or excellent (10).

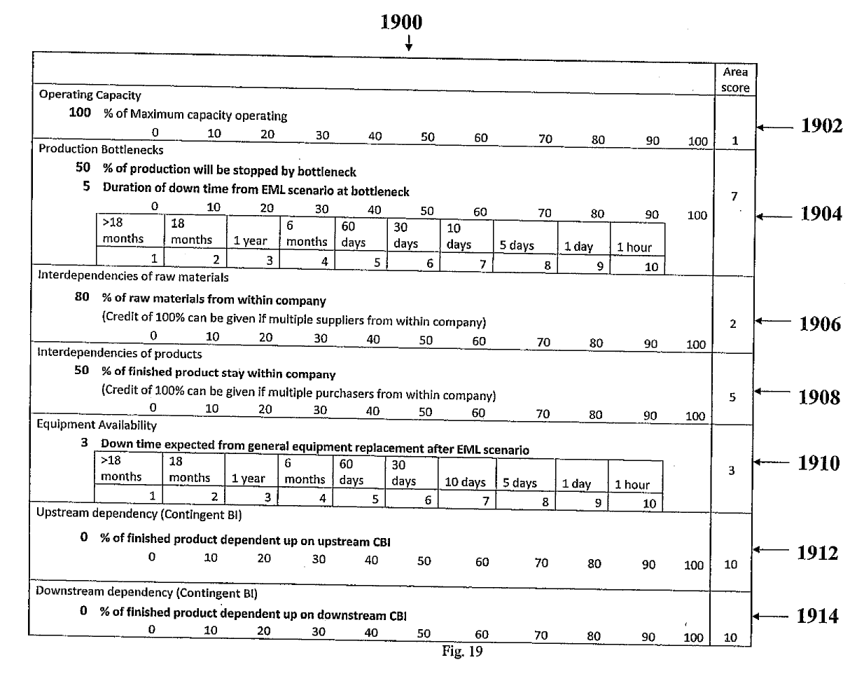

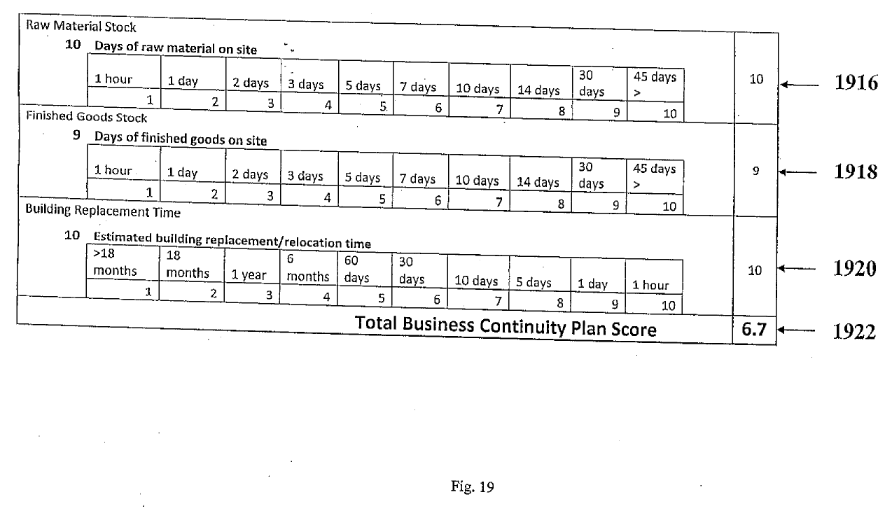

Referring now to FIG. 19, there is illustrated an exemplary business continuity plan 558 risk of loss assessment process 1900, comprising Area(N) matrix for operating capacity 1902, production bottlenecks 1904, interdependencies of raw materials 1906, interdependencies of products 1908, equipment availability 1910, upstream dependency 1912, downstream dependency 1914, raw materials 1916, finished goods stock 1918, building replacement time 1920 and the like, utilized to assess the business continuity required for operation of Area(N) of Property. More specifically, process 1900 preferably is utilized to determine the total business continuity plan score 1922.

Beginning with operating capacity 1902 of process 1900, for example, if Area(N) is determined to be operating at 10% of maximum operating capacity, the operating capacity Area(N) score is a 9 based on operating capacity 1902 matrix. Next, production bottlenecks 1904 of process 1900, for example, if a bottleneck exists in Area(N) where 100% of production will be stopped for a period of 30 days, then it is determined that the production bottlenecks Area(N) score is a 6 based on production bottlenecks 1904 matrix. Next, interdependencies of raw materials 1906 of process 1900, for example, if 10% of Area(N) raw materials come from within Area(N), then the interdependencies of raw materials score is determined to be a 9 based on raw materials 1906 matrix. Next, interdependencies of products 1908 of process 1900, for example, if 10% of Area(N) finished products stay within Area(N), then the interdependencies of products score is determined to be 9 based on interdependencies of products 1908 matrix. Next, equipment availability 1910 of process 1900, for example, if downtime is expected due to equipment replacement needed in Area(N), where 100% of production will be stopped for a period of 30 days, then it is determined that the equipment availability Area(N) score is a 6 based on equipment availability 1910 matrix. Next, proceeding to upstream dependency 1912 of process 1900, for example, if 90% of Area(N) finished products depend upon an upstream 3^{rd} party source, contingent business interruption (CBI), then the upstream dependency score is determined to be 1 based on upstream dependency 1912 matrix. Next, proceeding to downstream dependency 1914 of process 1900, for example, if 20% of Area(N) finished products depend upon down stream contingent business interruption (CBI), then the downstream dependency score is determined to be 1 based on downstream dependency 1914 matrix. Next, raw materials 1916, of process 1900, for example, if the number of days of raw materials on-site in Area(N) is determined to be 14 days, then it is determined that the raw materials availability Area(N) score is a 8 based on raw materials 1916 matrix. Next, finished goods stock 1918, of process 1900, for example, if the number of days of finished goods on-site in Area(N) is determined to be 14 days then it is determined that the raw materials availability Area(N) score is a 8 based on finished goods stock 1918 matrix. Next, building replacement time 1920, of process 1900, for example, if the number of days needed to replace or relocate Area(N) is determined to be one year, then it is determined that the building replacement time Area(N) score is a 3 based on building replacement time 1920 matrix.

Next, process 1900 calculates total business continuity plan score 1922 by averaging the scores from operating capacity 1902, production bottlenecks 1904, interdependencies of raw materials 1906, interdependencies of products 1908, equipment availability 1910, upstream dependency 1912, downstream dependency 1914, raw materials 1916, finished goods stock 1918, building replacement time 1920. Such number is business continuity plan 576 risk of loss rating for Area(N) under evaluation in step 350 of process 300. Upon completing the assessment utilizing the Objective Factors in process 1900, the next step is to insert the objectively determined numerical value of Area(N) based on process 1900 into row 32 of FIG. 5. Preferably, process 1900 is an objective business continuity plan 558 risk of loss rating system for poor (1-3), fair (4-6), good (7-9), or excellent (10).

Upon completing the assessment utilizing the Objective Factors in process 600-1900 and all Category(X) and Criteria(Y) of Areas(N) of Property have been objectively determined and their numerical values have been inserted into their appropriate row and column of assessment summary 500 in FIG. 5, process 300 i) calculates a summary of all Criteria(Y) for each Area(N) of Property in step 390; ii) calculates a summary of each Criteria(Y) for all Areas(N) of Property in step 392; iii) calculates a summary of all Criteria(Y) for all Areas(N) within each Category(X) in step 394; and iv) process 300 calculates the overall numerical risk of loss rating 578 for the Property in step 396.

Preferably, process 200 and 300 provides an overall plant or property rating based on the average of Category(X) averages (or Area(N) averages of Criteria(Y)) and Criteria(Y) ratings of Property's Areas(N), subsystem or sub-area to arrive at an overall numerical property loss rating for the Property.

Preferably, process 300 prompts the use of one or more risk evaluating criteria and queries Evaluator for the selection a numerical risk of loss rating from 1-10 for each criteria based on Objective Factors set forth in the risk summary matrix, wherein the risk summary matrix includes descriptions, matrix, tables, and audio/visual reference criteria utilized to differentiate each of the ratings from 1-10 for each Area(N), subsystem, or sub-area of the Property.

Preferably, process 300 analyzes assessment summary 500 performing statistical analysis and error calculations on the risk of loss numerical data and averages derived therefrom.

Now, when process 200 and 300 is implemented by the different insurers participating in a multi-insurer property loss insurance policy or the insured party is requesting the utilization of such a process, the resulting insurance policy submitted using process 200 and 300 is based on Objective Factors and the insured party reviewing each quote for coverage submitted by each insurer of the multi-insurer policy may directly compare and/or evaluate the assumptions and underlying premises that went into the risk of loss analysis, compare and/or evaluate the individual Area(N) ratings and scores for Category(X) and Criteria(Y), review the Category(X) and Criteria(Y) selected for assessment and evaluation, review the Areas(N) evaluated and any other differentiating data (Assessment Data) utilized in preparation and formation of each risk of loss quote. Ultimately, the insured party may utilize the Assessment Data to challenge individual quotes, to compare quotes, to make a direct comparison between insurance coverage providers, and to standardize the risk of loss assessment and analysis utilized by each insurer of the multi-insurer policy providing risk of loss coverage.

It is contemplated in an alternate embodiment that process 300 may include steps for recording the actual conditions of Areas(N) and their subsystem or sub-areas via recording formats including but not limited to text, audio, video, still pictures and the like.

It is contemplated in an alternate embodiment that process 300 may prompt an Evaluator, with instruction windows, to guide the Evaluator with the determination of the property risk of loss rating or score for each Criteria(Y), Category (X), and Area(N) by providing comparables via text, audio, video, still pictures and the like.

It is contemplated in an alternate embodiment that process 300 may make assessment summary 500 or other data or information acquired during an assessment available to other computer system 10 computer system 10 users via remote accessible or via the Internet.

It is contemplated in an alternate embodiment that process 300 is applicable to a risk of loss evaluation of a different properties and/or property in different industry segments, which require risk of loss evaluation and assessment utilizing different Criteria(Y), Category (X), Area(N), and differing Objective Factors.

It is contemplated in an alternate embodiment that process 200 and/or 300 could be performed utilizing a paper based system.

As such, the present system 10 and processes 200 and 300 advantageously provides for numerical risk of loss assessment of an insured property, in general, comprising the steps of evaluating one or more risk category, criteria for each area, subsystem, or sub-area of a property utilizing objective evaluation criteria and matrix tQ determine risk of loss numerical ratings for each criteria, category and area from 1-10 based on an objective analysis of the property's areas, subsystems or sub-areas; averaging the risk of loss ratings across each property areas, subsystem, or sub-area for each risk criteria and category to arrive at a category average); and averaging the category averages for each of the one or more category averages to arrive at an overall total risk of loss rating or score for the property.

Although the description given above includes specific examples of currently envisioned embodiments of the computer program, process, method, system, and/or apparatus, these possibilities should not be understood as limiting the scope of the present invention but rather as providing illustrations of some of the embodiments that are now preferred. Several examples of alternate embodiments are also described and various other alternatives, adaptations, and modifications may be made within the scope of the present invention. Merely listing or numbering the steps or blocks of a method or process in a certain order does not constitute any limitation on the order of the steps of that method or process. Many modifications and other embodiments of the invention will come to mind to one skilled in the art to which this invention pertains having the benefit of the teachings presented in the foregoing descriptions and the associated drawings. Although specific terms may be employed herein, they are used in a generic and descriptive sense only and not for purposes of limitation. Accordingly, the claims that follow herein and their legal equivalents, rather than the examples given in the specification, should determine the scope of present invention.

What is claimed:

1. A computer-based method of assessing numerical risk of loss of a property, comprising the steps of:
a) selecting a sub-area within the property to perform the numerical risk of loss assessment;
b) identifying one or more categories to evaluate risk of loss for said selected sub-area;
c) identifying one or more criteria within each category of said one or more categories to evaluate risk of loss for said selected sub-area;
d) identifying one or more matrix for objectively evaluating risk of loss for each of said one or more criteria;
e) obtaining an interactive computer software program capable of presenting each of said one or more criteria for each of said category to an evaluator; and
f) determining a numerical score for each of said one or more criteria for each of said category based on objective evaluation of said sub-area to said matrix.

2. The method of claim 1, wherein said interactive computer software program records said numerical score for each of said one or more criteria for each of said category for said sub-area.

3. The method of claim 1, further comprising the step of said interactive computer software program averaging said numerical scores for said one or more criteria for said sub-area.

4. The method of claim 3, wherein said interactive computer software program records said averaged numerical score as a sub-area risk of loss numerical assessment average for said sub-area.

5. The method of claim 1, further comprising the step of determining a numerical score for each of said one or more criteria for each of said category for each said sub-area within the insured property.

6. The method of claim 5, further comprising the step of said interactive computer software program averaging said numerical scores for each of said one or more criteria of each of said category for each of said sub-areas within the insured property.

7. The method of claim 6, wherein said interactive computer software program records said averaged numerical scores as a sub-area risk of loss numerical assessment average for each sub-area within the insured property.

8. The method of claim 7, further comprising the step of said interactive computer software program averaging said numerical scores for all sub-areas for each criteria of said one or more criteria of each of said category.

9. The method of claim 8, wherein said interactive computer software program records said average numerical scores as criteria risk of loss numerical assessment for said sub-area within the property.

10. The method of claim 7, further comprising the step of said interactive computer software program averaging said sub-area risk of loss numerical assessment averages as a total property score risk of loss numerical assessment for the insured property.

11. The method of claim 10, wherein said interactive computer software program records said average numerical scores as a total property score risk of loss numerical assessment for the property.

12. The method of claim 9, further comprising the step of said interactive computer software program averaging said criteria risk of loss numerical assessment averages as a total property risk of loss numerical assessment score for the insured property.

13. The method of claim 12, wherein said interactive computer software program records said average numerical scores as a total property risk of loss numerical assessment score for the property.

14. The method of claim 9, further comprising the step of said interactive computer software program recommending risk of loss improvement evaluation for said sub-areas, said one or more criteria, or said one or more categories low numerical scores.

15. The method of claim 9, further comprising the step of said interactive computer software program reporting one or more criteria and category risk of loss numerical scores, and sub-area risk of loss numerical assessment, criteria risk of loss numerical assessment, and total property risk of loss numerical assessment scores for the property.

16. The method of claim 15, further comprising the step of said interactive computer software program performing statistical analysis and error calculations on one or more criteria and category risk of loss numerical scores, and sub-area risk of loss numerical assessment, criteria risk of loss numerical assessment, and total property risk of loss numerical assessment scores.
